(19) United States
(12) Patent Application Publication
(10) Pub. No.: US 2024/0203074 A1
(43) Pub. Date: Jun. 20, 2024

(54) Metaverse Taxonomy

(71) Applicant: Wesley Boudville, Altadena, CA (US)

(72) Inventor: Wesley John Boudville, Perth (AU)

(21) Appl. No.: 17/803,833

(22) Filed: Dec. 19, 2022

(51) Int. Cl. G06T 19/20; G06F 3/16; G06T 13/40

(52) U.S. Cl. CPC G06T 19/20; G06F 3/16; G06T 13/40; G06T 2219/024; G06T 2219/2024

(57) ABSTRACT

A taxonomy method of classifying activity in the Metaverse is explained. It connects an interaction between 2 or more avatars. Typically resulting in 1 or more avatars “jumping” to other Metaverse sites. Also described is a method of protecting avatars from an avatar Predator who tries poking the eyes of others. Eye protection is used, which also Jumps the Predator to a punishment site.

### BACKGROUND

The Metaverse is essentially Virtual Reality (VR) combined with a requirement that users use avatars. An avatar is a 3d skin worn by a user, when she goes to a VR site. The site may have links to other VR sites, run by the same operator or firm who runs the first site. Or the site might have links to VR sites run by different operators or firms.

A link is put in the first site. A user uses her avatar to lick the link, which takes her to a destination site. But given rampant bad behavior documented for the Metaverse, she might be leery of doing so. Existing bad behavior includes sexual harassment, plus what some women have characterized as virtual rape.

There Is little appreciation of what VR really can do, for a person with an avatar in a VR site. In this application, we describe in further detail several cases.

### BRIEF DESCRIPTION OF THE DRAWINGS

FIG. 1 shows Susan's avatar and other avatars in a VR site.

FIG. 2 shows Susan sending images of her clothing to the VR site.

FIG. 3 shows Susan's dresses and Abdul picking 1 for her to wear just for him.

FIG. 4 shows Susan's hats and Abdul picking a hat for her to wear just for him.

FIG. 5 shows Susan's bracelets and Abdul picking 1 for her to wear just for him.

FIG. 6 shows Abdul sending his choices of hat, dress and bracelet to Susan.

FIG. 7 shows Abdul and Rajan sending Susan dresses to wear.

FIG. 8 shows Creep groping Jody.

FIG. 9 shows Creep being put into a blacklist of bad avatars.

FIG. 9A shows a tombstone of Creep made by the punishment site.

FIG. 9B shows a Jail site with Creeps found by the punishment site.

FIG. 9C shows a captive Creep with an animate button.

FIG. 9D shows details about avatar Creep touching another avatar.

FIG. 10 shows an avatar jumping between VR sites and audio announcing this.

FIG. 11 shows audio played at the destination, to announce an incoming avatar.

FIG. 11A shows an avatar having a Jump that points to the previous site.

FIG. 11B shows avatar Bob showing his History to avatar Carol.

FIG. 12 shows an example of eye protection.

FIG. 13 shows how to Jump from inside a crowd.

FIG. 14 shows possible avatar-avatar interactions that use Jumps.

FIG. 15 shows a taxonomy of Jumps.

FIG. 15A shows 2 avatars interacting via a high 5.

FIG. 16 expands the taxonomy to include mirror image cases.

FIG. 17 shows 3 hand avatar-avatar interactions.

### DETAILED DESCRIPTION

What we claim as new and desire to secure by letters patent is set forth in the following. This application has the sections:
0] Definition of Metaverse;
1] Problem;
2] Solution;
3] Variants;
4] Social viewing;
4.1] Runway for models;
5] Anti Rape measures—part 3;
5.1] Same site;
5.2] Different for buttocks and pubic region;
5.3] Back button;
5.4] Tombstone—weaponizing the Jump;
5.5] Jail holding Creeps;
5.8] Protecting kids, pets;
5.7] Protecting statues and museums;
5.8] How 2 avatars intersect (touch);
6] Cloud link/jump;
7] Jump parameters and actions;
7.1] Burp and chirp;
7.2] Haptic;
7.3] Smell;
7.4] Send avatar to the previous site;
7.5] Show the avatar's travel History;
8] Non VR;
9] Eye protection;
10] Jumping from inside a crowd;
11] Avatar-avatar interactions;
11.1] Taxonomy;

### 0] Definition of Metaverse;

We take a pragmatic definition of Metaverse as being VR plus the use of avatars within the VR sites. This sidesteps various hyped-up discussions of what a Metaverse might or can be. But the requirement of VR can even be optional. So what a user sees can be a 3D environment similar to what is often shown in combat or car driving games. In this case, avatars are still required.

### 1] Problem;

We discuss human users and their avatars. For simplicity, we shall call a user's avatar by the user's name. It should be clear by context whenever we mean the human or the avatar. In some cases, we will explicitly refer to a “human” or an “avatar”.

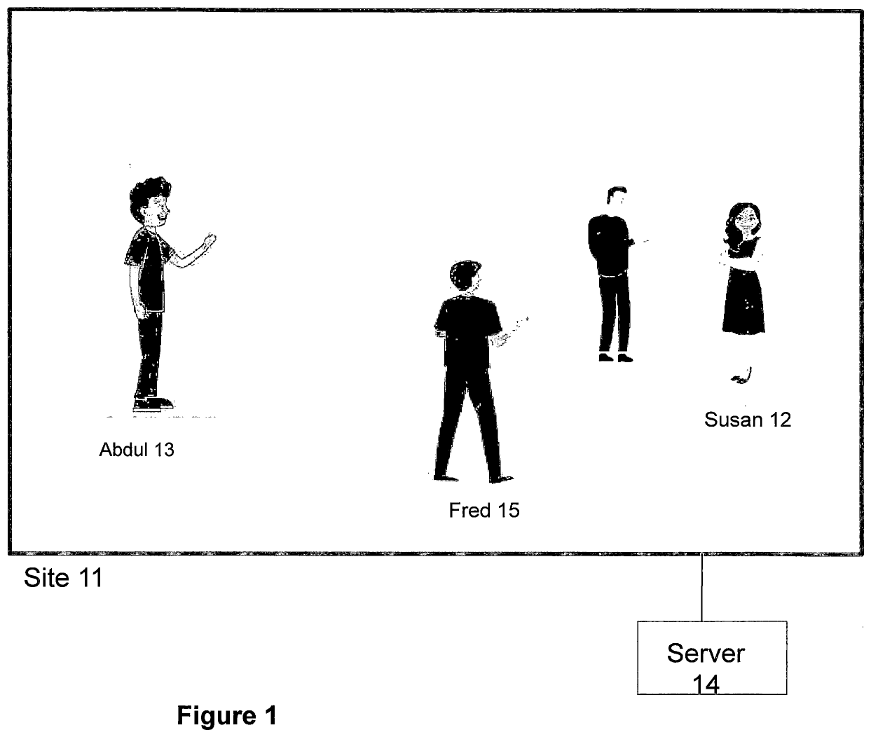

There is a human user Susan with an avatar. The latter is fully clothed; she wears virtual clothes. See FIG. 1. It shows VR site 11 and Susan's avatar 12. Near her avatar is avatar Abdul 13. He is clothed. He is run by a man, and the man wishes to see avatar Susan wearing fewer clothes. The context of FIG. 1 is where there are other avatars present. Most, If not all, are clothed. We can imagine site 11 as a conventional meeting in the real world or VR, where most are clothed.

It is a common male fantasy in such situations where he is looking at a clothed woman, to Imagine her in fewer clothes. Normally in the real world, he can only Imagine in his mind.

### 2] Solution;

Imagine that site 11 has a server 14. When an avatar jumps to site 11, this means the server 14 gets (=copies) an image of the avatar. The source of the avatar can be a computer of the owner, or a third party computer that, in part, holds avatar data for many avatars. The copy is stored on server 14. For fast computing, the site server will want to keep a copy on what is to the server, a local computer. When the avatar owner moves the avatar, the commands go from the user computer, like some type of HUD device worn by the user, to server 14. The movement commands are implemented by server 14 and the avatar image is updated.

In VR, site 11 makes an image of Susan that would be visible to Abdul, at his eyes' Field of View (FoV). This image (there might be 2 Images, 1 for each of Abdul's eyes) is sent to Abdul. For the moment, we assume Abdul has an unobstructed FoV of Susan.

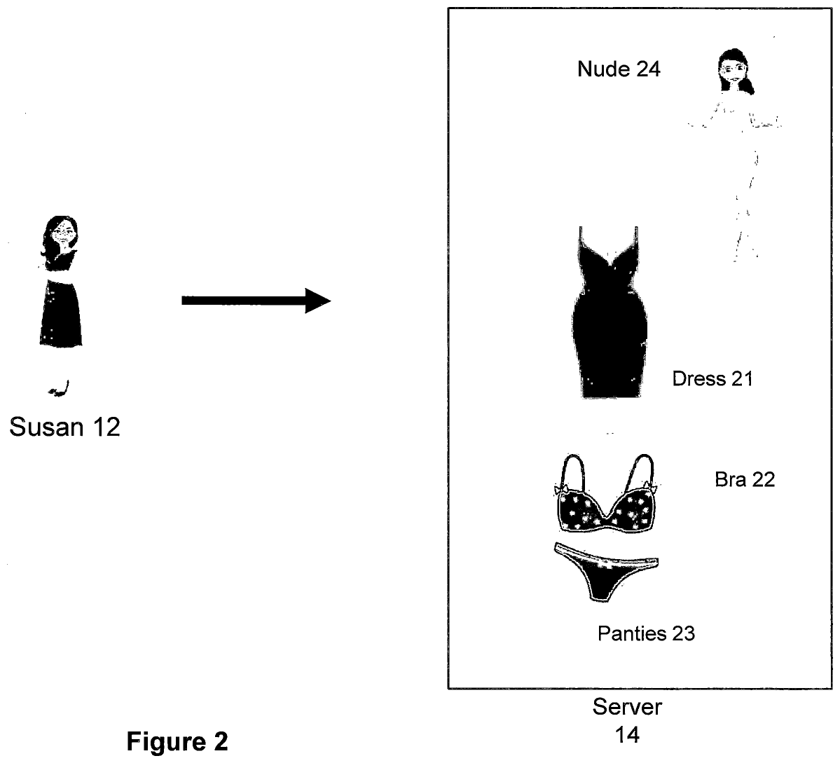

At some earlier time, like when Susan has just jumped to site 11, she hands to site 11 several images. See FIG. 2. Susan also sends images of her avatar in the nude—Nude 24. And images of the underwear—bra 22 and panties 23. Plus an image of her dress—dress 21. Note that when we say images, we do not in general mean just a photographic image of an item at some viewing angle. Image here refers to a 3d wireframe (“polygon mesh”) of the item.

Suppose when Abdul jumped to site 11, the site presents him with images of Susan. The default image can be of her fully clothed. Next to the image of the dress can be “$1”. This means if Abdul (actually of course Abdul's human owner) pays that amount, he can see her without the dress. This can be continued, with details dependent on the UX. By paying more, he can see her without more of her clothes.

Whereas avatar Fred 15 did not pay any extra. Fred gets from the site an image of Susan clothed. He sees this and hears her talking. But if Abdul pays (eg) that $1, he can see Susan without her dress. If (eg) he pays another $1, Abdul can hear Susan talking and see her just wearing panties. Etc.

A trivial adjustment in the UX is to let Abdul, when he first jumps to the site, to see Susan and her clothes. By each item of clothing is a price. He can decide then to pay to not see that item on her. Rather than have Abdul decide later, which other of her items should be removed. The reader can see that both are equivalent. Though having Abdul progressively pay relatively affordable amounts can more easily encourage those payments, compared to an initial total paying. The delay in what he can see increases anticipation and, hopefully, payment.

Such a selectable viewing of Susan is not possible in real life. This is significant We point out here a unique aspect of the Metaverse vis a vis real life. The Metaverse is more than just a simplistic reification of the real world.

The actions of this application are possible because Susan sends the VR site images of her and her minus items of clothing. She consents to her display as partially nude or totally nude. But “consents” can be better replaced by a more affirmative term. She is getting paid by the site, and ultimately by the owners of the male avatars. She wants the men to look at her in various stages of undress.

Another way this differs from the real world is that if Susan is de facto acting as a stripper, she is actually acting more precisely as a lap dancer. The latter in real life goes with a male customer to a room. She disrobes and dances in front of him only. This means that a lap dancer faces more sexual harassment than a stripper in a room full of men. In this VR application, Susan can derive more income, because she is being paid in parallel (in the computing sense) by several avatars (=people).

The site uses the images of Susan and her clothes to draw or redrew her in any combination of these. The field of cloth physics is advancing. This describes how to draw a piece of clothing when it is worn by someone, realistically. Cloth physics takes into account the thicknesses of the clothing, the type of fabric used and the presence of any clothing underneath, And other factors, like how the clothing folds as the user moves. The current state of the art for avatars is to simply draw an avatar in whatever outer clothing she wears, where the combination is used as just a single object.

This section of the application anticipates future progress. We expect that a computer (the VR site server) can solve the problem of combining an avatar in just underwear with a given dress, and depicting this combination as the avatar moves. Even when the server does not have images of the avatar wearing the dress.

One possible action for Susan is for her to be dancing fully clothed. She offers the audience the chance to see her dance in varying levels of undress.

A further advance is where imagine Susan avatar just appears in the site wearing a dress and underwear. She does not give the site images of her nude or of her underwear. A future server might extrapolate from her images, based on its knowledge of human anatomy. It would offer to patrons the way to outfit her with other dresses and underwear. The site makes a wireframe of her nude body and dresses it with a choice of dress and underwear. It might be objected that, for example, this is fake, if the site has no images of her nude. But Susan is an avatar. Her nude figure is likely purely computer generated, even for the original avatar So if the site makes a new depicted, n nude avatar, there might be no practical difference.

One exception is where the human Susan is a real person, like a celebrity. She can make a photo-realistic avatar of herself. She might attest publicly about this. So her avatar could attract people to the VR site.

### 3] Variants;

What if Abdul's view of Susan is blocked by other avatars? It does not matter, because when the site makes the images that would be seen at Abdul's location, it can disregard the presence of other avatars that might otherwise block his view.

The site can choose to exploit this. If there are avatars standing between Abdul and Susan, partially or entirely blocking his view of her, the site might compute a view, as seen by Abdul. The site can inform Abdul that if he pays extra, the blocking avatars can be disregarded by the site.

What if Abdul gets a video feed of Susan and then sends this to others, especially to those who might be in site 11 and who have not paid for the extra views? One answer is simply to disregard this case. It might be considered that this deliberate lack of enforcement might help to promote the attending of full paying users like Abdul.

But suppose Abdul gets this video feed to his eyes. It comes from the site. And goes to his HUD (or whatever device he is using to watch and be in the VR site). If his device can interpose a filter between the incoming video and the copying and forwarding of it to others outside the VR site, then it can do so. Perhaps under the direction of the VR site. This interpose can be ads by the site or other firms.

Another variant is for Susan to start talking, while veiled like a Muslim woman. This may been seen as attractive to some men. And very more attractive if she was unveiled. The latter can be done by her veil being removed by the actions of this application. She never actually unveils with her hands.

Another variant is where Susan wears one or more necklaces. Perhaps one or more rings on one or both hands. Perhaps a headband. Perhaps a scarf. Unlike the Muslim scenario, the scarf might be purely secular. Uke her clothing, these items can be removed in what is shown to the audience of avatars.

This can be extended to the dress that Susan wears. Abdul might prefer her to wear a digital dress that he provides her. Or perhaps if she wears (eg) a knee length dress, he offers a blouse and skirt as an alternative.

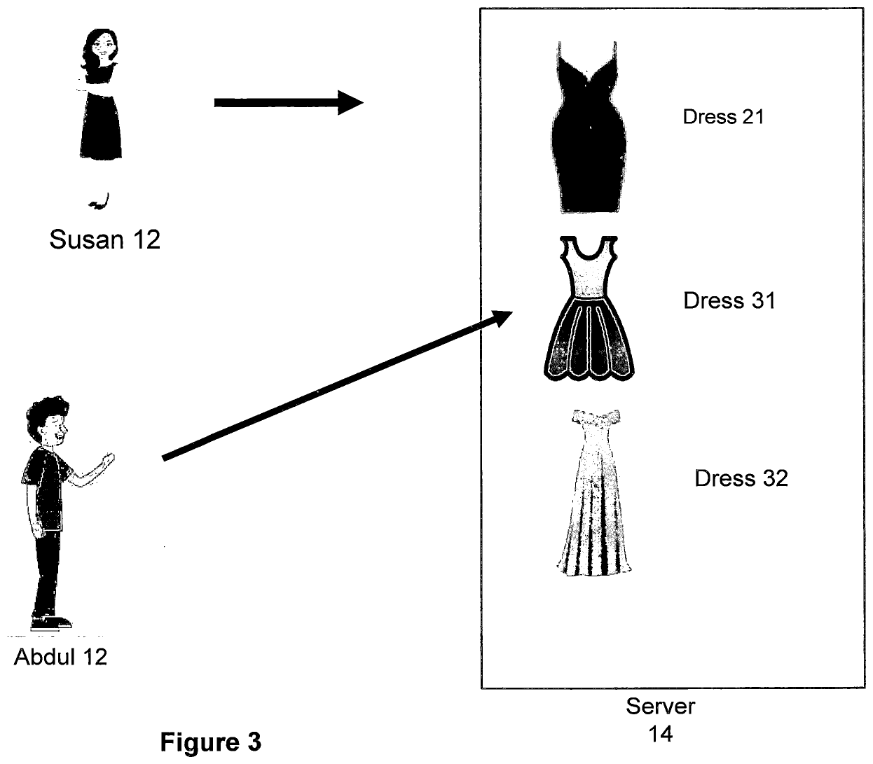

Or maybe Susan has a wardrobe of digital dresses in FIG. 3. She is wearing a given dress by default. But when Abdul appears in the site, she lets him see her dresses. He can pick one that she wears, only for him to see. He picks dress 31.

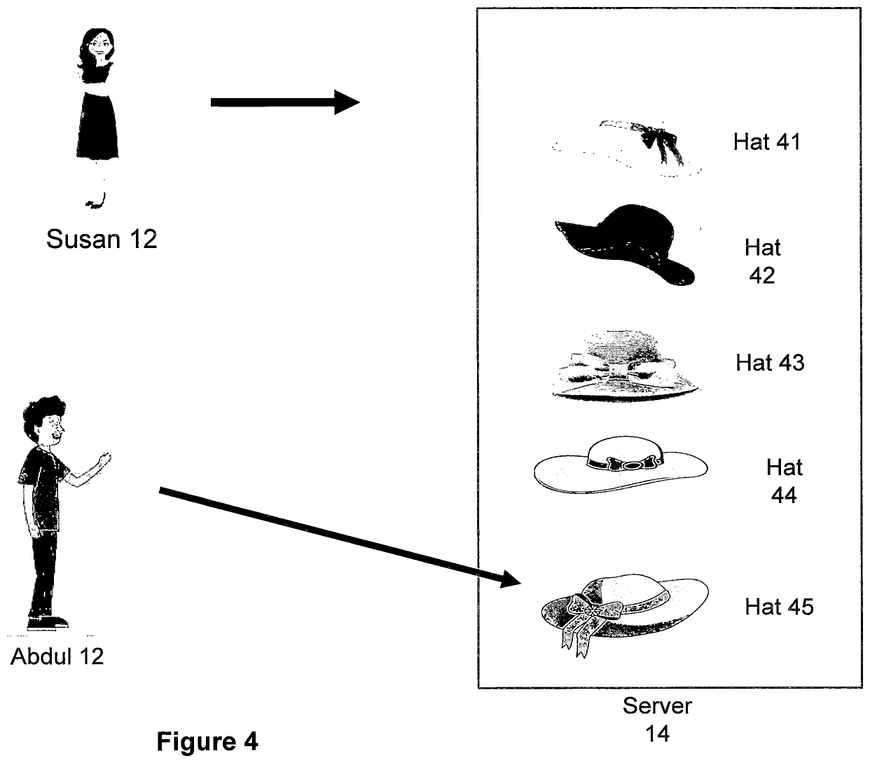

FIG. 4 shows Susan showing 5 hats to Abdul. He picks hat 45 for her to wear, just for him to see.

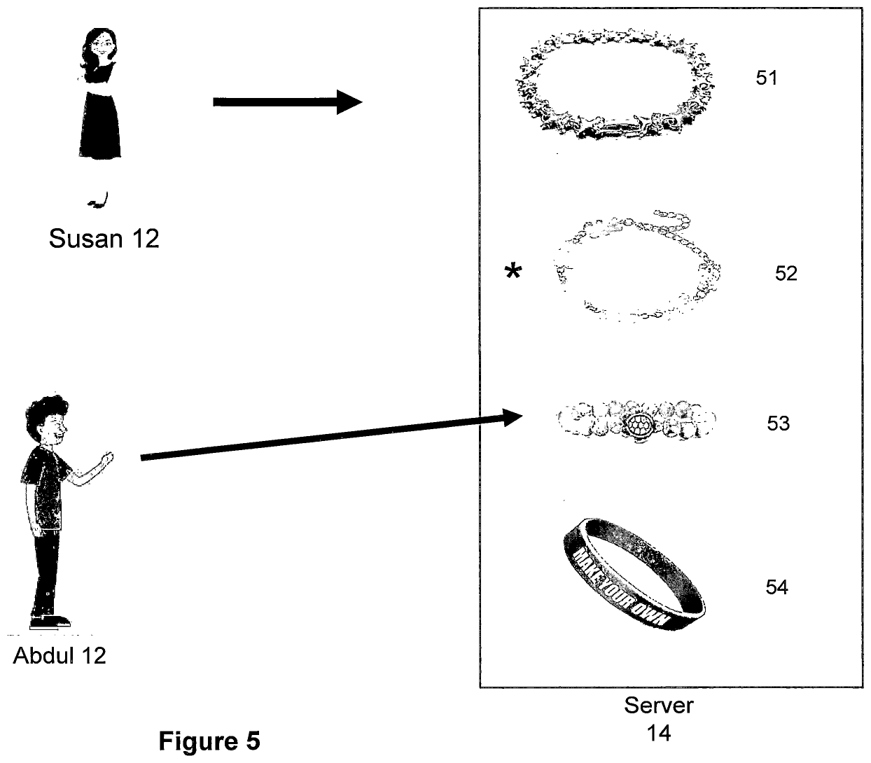

FIG. 5 shows Susan showing 4 bracelets to Abdul. He picks bracelet 53 for her to wear, just for him to see. FIG. 5 also shows a star next to bracelet 52. This indicates that this is the favorite choice of other avatars watching Susan. Abdul decides to disregard this, by picking bracelet 52. Note that item 54 is qualitatively different from the other bracelets. Item 54 is not (digital) jewelry, but represents a plastic band. Such is possible with Susan's choices.

Plus, Susan can show a wardrobe of blouses and skirts, instead of dresses.

Similarly, Susan can show a wardrobe of her underwear to Abdul. He can pick a choice of bra and panties for her to wear, just for him to see. The bra he picks can be from a different set than the panties he picks. The details are left to the reader.

Another variant is where Susan is tattooed. She might be wearing a dress that exposes skin and tattoos. Or perhaps under the dress, she has tattoos. Abdul may be able to cause a tattoo to not be shown.

Another variant is if she does not have a nose piercing, and Abdul wants her to have one. In VR, this is trivial to accomplish. Likewise with earrings and tongue piercings. And with labia piercings or (if Susan is substituted by a male) with penis piercings.

A different type of variation is where Abdul can pay Susan to wear some clothing or item. He might have a virtual headband and some rings for her left hand. He might ask her to wear these. The asking can be done before she (eg) does a dance. Abdul can present his rings (etc) to show her at the start. And for each item he wants her to wear, he can cite a price he will pay her to do so. One type of price for an item can be if only he can see her in his vision, wearing that item. The other type of price is where if she wears it, all in the room who are seeing the default images of her will see those items.

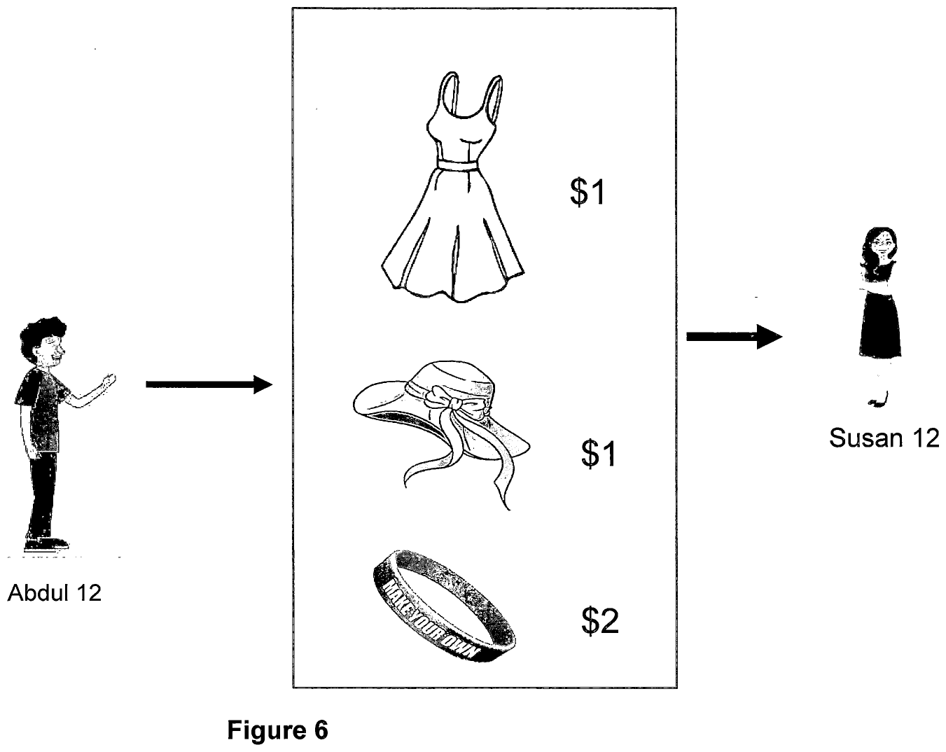

FIG. 6 shows Abdul offering his choices of a hat, dress and bracelet to Susan. The choices were made by him. Either he made the virtual images himself or he got them from other sources. (The latter is more likely.) In general, Susan has never seen these choices in her wardrobe. By each term is the amount that Abdul will pay Susan if she puts on the item. Note that the highest value is on a bracelet Perhaps that bracelet (or its real world equivalent if Abdul has it) has sentimental value to him.

A variant is where some of the amounts might be $0. Depending on the rules of VR site 11, Abdul might not have to pay anything.

Another case is where different avatars offer Susan different items to wear, where each item can only be seen by the avatar who offered it. The latter case is where the price being offered Susan is higher precisely because only one avatar's item/s can be worn and shown by Susan. There can be various ways that item can be chosen. A simple method is to let Susan automatically pick the most expensive items. Or she can use those prices as a guide. She would treat the prices as suggestions. Susan can conduct an auction to determine which dress (or rings or necklaces etc) she solely wears.

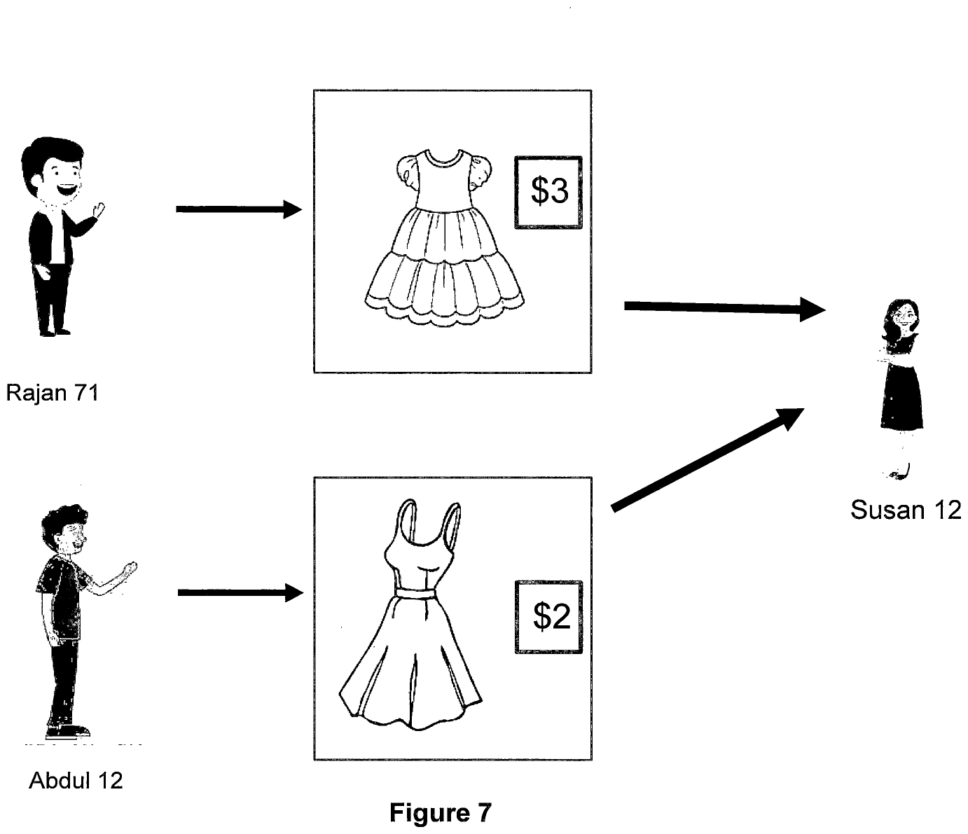

FIG. 7 shows Abdul and Rajan 71, each sending a dress to Susan. Abdul offers her $2 if she will wear the dress he picked. while Rajan offers her $3. In this case, Susan can manually decide. In other cases, Rajan would automatically win and his choice of dress will be worn by her. In this Figure, the boxes around the dollar amounts indicates that Abdul and Rajan each wants his dress to be the only one worn by Susan.

If Susan has some tattoos and Abdul offers others—perhaps for the same place on her skin. She can to choose to temporarily remove her existing tattoos and use what he provides. This differs from the real world in 2 respects. First. In VR, Susan can easily and temporarily remove a tattoo. Second. She can easily add the temporary tattoo offered by Abdul. In the real world, even if Susan wears a real world temporary tattoo, she cannot usually just remove it in a few seconds to replace with a new (temporary) tattoo.

A caveat is about what Abdul wants her to wear. It might not be compatible with the cloth physics of her other clothing that she plans to wear. Or compatible with the headbands or necklaces that she wears. This can be a restriction imposed by the dance steps and arm movements that she plans to do. If the headband or necklaces are well simulated, they might not be compatible with the clothing.

An important variant is where Abdul wants Susan to change her skin color or racial or ethnic features. As with the above, a change might only be visible to him. And a bigger change is if it is visible to the others.

### 4] Social Viewing;

Suppose several viewers of Susan have paid various amounts to see her in a state of undress. There can be Abdul and now Rajan and Ralph. The VR site 11 is the computational entity interacting with all 3 men. It can show a common graphical window in their displays. The window can let them interact with each other. An example is a textual chat window and a graphic of Susan. This can be what is seen by Abdul. Suppose Rajan did not pay as much. Abdul can describe to Rajan (and others) what Rajan can see if he pays up. This social pressure acts on Rajan to persuade him to spend money. By implication, Ralph might be induced to also pay up, just by seeing or hearing Abdul. This acts as a new variant of social media interaction.

But given advances in voice interactions, we can imagine a merger of the text chat with voice chat, where the latter might be converted to text. For example, the chat text window might be entirely replaced by an audio window, where all users interact via spoken input. Or the text is all converted to vocals.

Susan, or an associate of hers, might also be in on the chat window. The associate might be another human. Or it could be a bot (software entity). The bot could surveil the existing content of the chat and derive from that window suggestions for Susan. Because Susan Is already using her avatar in real time, it is easier if she has an associate to handle analysis of the chat. Though an extrapolation is for her associate to be AI generated.

### 4.1] Runway for Models;

A related case is a VR runway for models. Virtual models can strut on a runway in front of an audience of avatars. While the earlier cases described a predominantly de facto audience of male avatars, the current case can have the audience be mostly female. The models and be female or male. Usually a model parades by herself, but is followed immediately by other models. One aspect of real world modelling is that there are many models in the same parade. In VR, there might be many fewer. Indeed perhaps only 1 avatar model. The same model parades wearing different outfits. In the real world, there is a major cost of having all the models. Multiple models are needed because of the time taken to put on each dress.

But in VR, a dress can be taken off or put on immediately. And for a given model, her hairstyle, hair color, and how much hair she has can also be immediately changed. Plus, depending on the software used to render her features, her face might also be rapidly altered.

A counterpoint is that in the real world, having several models is sometimes not necessarily seen as a negative. Part of the attraction of a real parade is to see different models.

In VR, some models might only model 1 outfit each. While other models each models several outfits.

Another feature of a VR parade is that what exactly a model wears can now be chosen by various new means, along of the lines of what was described in earlier sections. A member of the audience can offer a sequence of outfits to a model, to be worn one at a time. Or a given model might wear items offered by different members of the audience.

A given outfit, perhaps worn by a model, can now be chosen by the audience to be worn by a second or third model. This is an easy way to see if the outfit is better suited to a given model's features.

Plus a given outfit might be available so that it can be adjusted in size simply by varying a parameter. Whereas in the real world, most outfits cannot be changed in size. In VR, an outfit can be shown on a model of a first size and then, if the audience agrees, it can be worn on a taller model, for example.

Another issue is hygiene. There may be regulations about underwear or swimwear. Restricting these to only be worn by one user. In VR, there is no such requirement. A given outfit can be worn by others.

A VR runway can be a fundamentally more interactive experience for the audience and the models. In the real world, what the models wear is determined beforehand by designers. Now, a pick and choose approach is feasible.

### 5] Anti Rape Measures—Part 3;

This section expands on our recent patent pending application “Metaverse Anti Rape Measures—part 2”. That application described a case where a male avatar touches [eg] underwear worn by a female avatar. The underwear might be bra or panties. The owner of the female avatar wants the underwear not to be touched by other avatars. She (the owner) defines the underwear to be clickable. And when another avatar touches the underwear, this clicks a link that points to an undesirable VR location D. A punishment site. He is sent there and subjected to unpleasant noises and sights.

Some countermeasures can be done against predators who try to abuse the methods. For example, a predator with an avatar might put all of its avatar exterior clothing and skin surface to be linked to the punishment site. The aim by the predator is to walk its avatar thru a site. And deliberately bump into other (and innocent) avatars. This triggers the Jumping of the latter innocent avatars to the punishment site. Instead, one countermeasure can be that the site has exterior clothing (jackets, blouses, dresses etc) of avatars unavailable for linking to punishment sites. Exceptions can be certain clothing (eg bikinis, swimsuits) and underwear. Here, the aim is that touching of these might correctly trigger the Jump even if the clothing is worn openly as exterior clothing.

The intent of the previous remarks is to guard against the second order effect of a predator attempting to exploit the methods. The first order effect is where normal innocent users use the methods to protect their avatars against sexual harassment. If this is successful, the second order method might arise by predators, to try to discredit the first order methods.

Another way to defend against a predator abusing the first order methods is for a site to surveil Incoming avatars. The site looks for avatars with links from their exterior surfaces (the outsides of dresses etc) to punishment sites. The addresses of the punishment sites are or will be well known. So if a site finds that a newly arrived avatar has a dress with a link to one of those sites, it can take measures like:
a) Remove the avatar from the site.
b) Let the avatar remain. But if the link from the avatar's outer clothing is triggered, and goes to the site server, the site will not send the other avatar, which triggered the link, to a punishment site.

Another site protection method can be to rescan avatars that have been in the site for some time. This guards against a predator jumping to the site with an avatar that does not have links from its exterior clothing to a punishment site. Then after some time being spent for the predator in the site, it makes links from its exterior to punishment domains. And then the predator tries to bump into innocent avatars, to send the latter (wrongly) to punishment.

### 5.1] Same Site;

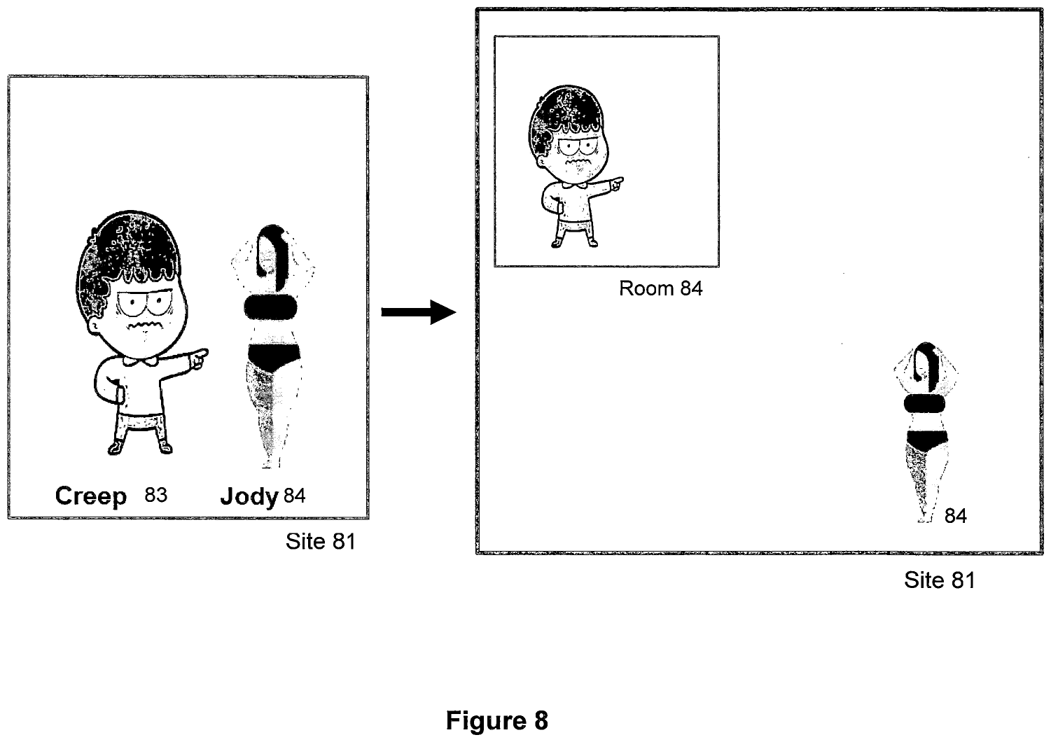

The punishment location D is, in general, different from the VR site A, where the male and female avatars are in. But in the current application, we now Include the case where the undesirable domain D is also site A. Here, the offending male avatar is sent to a different place in site A. Perhaps simply a distant location in A. Or perhaps a room that acts as a punishment room in A. See FIG. 8. It shows VR site 81 containing avatar Jody 84 and Creep 83. He gropes her underwear. This triggers a click that hurls him into room 84, which is still in site 81. Note that in the right of FIG. 8, Jody is now very separate from him. Room 84 can be considered to be some type of punishment room that attempts to confine him and punish him. Though by default, the punishment can be considered simply to be the removal of him from near Jody.

Also, the earlier application described domain D as playing an unpleasant sound and showing an unpleasant video. In the current application, this can be expanded to simply requiring a sound S and a video V. The sound S might even be null, though in this case V should not be null. And V might be null, but then S should be some type of sound.

### 5.2] Different for Buttocks and Pubic Region;

In our earlier application, we described how a female avatar might assign a clickable link to her entire panties. So if another (usually male) avatar were to touch her anywhere on her panties, it would trigger the jump to send him to a punishment site. A variant is where she treats different parts of her panties differently.

If the other avatar touches the rear of her panties, which covers her buttocks, this will now no longer trigger the jump. Whereas if he touches the front of her panties, which covers her pubic region, a jump will be triggered. This does not imply that she (the human owner) regards someone touching the rear of the panties to be ok. But she is willing to overlook a possible transgression. For example, the man with a male avatar might slap the female avatar's covered buttocks. He could regard this as a friendly gesture. And so might she. So she pre-emptively does not put a trigger on the rear of her panties. Whereas a different female avatar could disagree and thus put a trigger on all of her panties.

Continuing along these lines, consider when a female avatar is naked. Previously she might protect herself by making a region around her vagina and buttocks to be clickable, where this jumps the other avatar to a punishment site. Now, she might let her buttocks not be clickable. But the area around her vagina, and her vagina, is clickable. She protects her vagina.

Going further (ahem), consider where a stripper avatar takes everything off. She wants others to donate (digital) money into her vagina. The money can be represented as bills that are folded. During this, the male might inadvertently touch her labia majora (outer labia). But if he puts his fingers or anything else deeper in, she wants that off limits. So she defines the inner vagina with a Jump to the punishment site.

### 5.3] Back Button;

In our earlier application and this application, one counteraction the Creep can have is simply to click the Back button. This assumes that he is using a browser or a HUD gadget, where the latter has implemented the equivalent of a browser Back button.

Consider how a Back button is done in a browser. The browser keeps a stack (in the computer science meaning of the term) of previous sites it has been to. The top of the stack is the most recent previous site. The entry below this is the site that was visited before the most recent previous site. Etc. Suppose the Creep finds himself at a different site than Jody. This site is the punishment site.

He might want to return as soon as possible to site 81. Assume that his browser or HUD has a Back button. When he clicks it, his device tries to load site 81. The Creep has a current Internet address of the punishment site. This is his source address. His destination address is that of site 81. But site 81 can check the source address of an incoming connection. If the source address is the punishment site, site 81 can assume that anyone at that address has been penalized. And such a link can be refused by site 81. This is straightforward to do, and very quick.

But the Creep, at the punishment site, might connect to site 81 via [eg] a TOR network. This is a set of sites that hides the fact that a user is coming from the punishment site. Or the Creep might simply go from the punishment site to an innocent site, and from there go back to site 81. So a more complex method is needed. Site 81 might accept the connection that actually comes from the punishment site. For any avatar, this means site 81 gets a pointer to his avatar, which in general is stored on a different site than the punishment site. Or site 81 gets a copy of his avatar. Or site 81 gets an “abbreviated” copy. The latter can implement a “lazy loading”, where only a subset of the avatar is copied to the (anticipated) destination. And the rest of the avatar is copied on an as-needed basis.

But the point is that site 81 will now get information about the avatar of Creep 83. However, when just earlier site 81 sent the Creep to the punishment site, site 81 notes that it is sending an avatar to the latter. Site 81 retains a copy of the Creep in site 81's memory, for the special case of an avatar going to the punishment site. In general, site 81 will not do this for most avatars leaving site 81.

Hence when the Creep's owner presses the Back button, the destination site is now site 81. The latter checks information about the incoming avatar against a copy of the previous outgoing avatar. At a minimum, an avatar is defined by a polygon mesh of the shape of the avatar. If site 81 gets a full copy of the incoming avatar, it can compare this to its copy of the outgoing Creep. Site 81 sees the match. It rejects loading the incoming avatar.

With lazy loading, site 81 might not have the full information about the incoming avatar. But even with this incomplete information, there might still be enough for site 81 to compare this to its stored copy of the outgoing Creep. It then rejects the incoming avatar.

The match between a stored copy of the Creep, when it was at site 81 earlier, and the copy incoming does not need to be exact. AI methods can be used to find a partial agreement that might be deemed sufficient to reject the incoming avatar.

This comparison of one avatar to another is a fundamental difference with earlier antispam tests of a domain in an email link with a blacklist of bad domains. Now with avatars, we are comparing a polygon map against another polygon map. There is no analogous blacklist test of domains in antispam.

An extension of this is where site 81 keeps copies of avatars that it sent recently to the punishment site. So even if the Creep waits (eg) 12 minutes after he is sent to the punishment site, to get back to site 81, he can still be detected and rejected. This is true even if during that minutes since he was put in the punishment site, he moves to a different third party site, before trying to jump back to site 81.

This can be extended. Imagine the Creep is like a bad domain in email spam. In the 2000s, a very effective antispam method was for a mail server to collect the names of bad domains found. And then for incoming mail, going to any users serviced by the mail server, the server could test domains in links in incoming mail against the list of bad domains. In the present situation of detecting bad avatars, a list of the descriptions of such avatars can be compiled. Site 81 can forward its list of bad avatars to a central site. In turn, the latter can promulgate the list (and updates to it) to other VR sites.

Thus a bad behaving avatar on site 81 can trigger the adding of that avatar to a blacklist of avatars, for use by a much greater collection of VR sites.

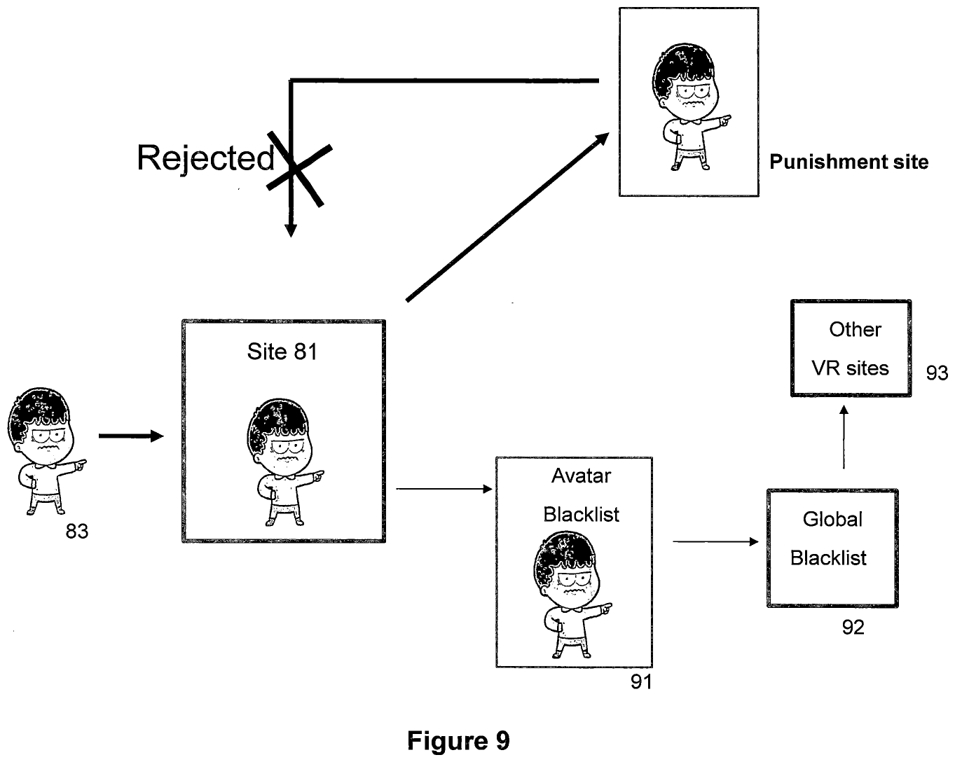

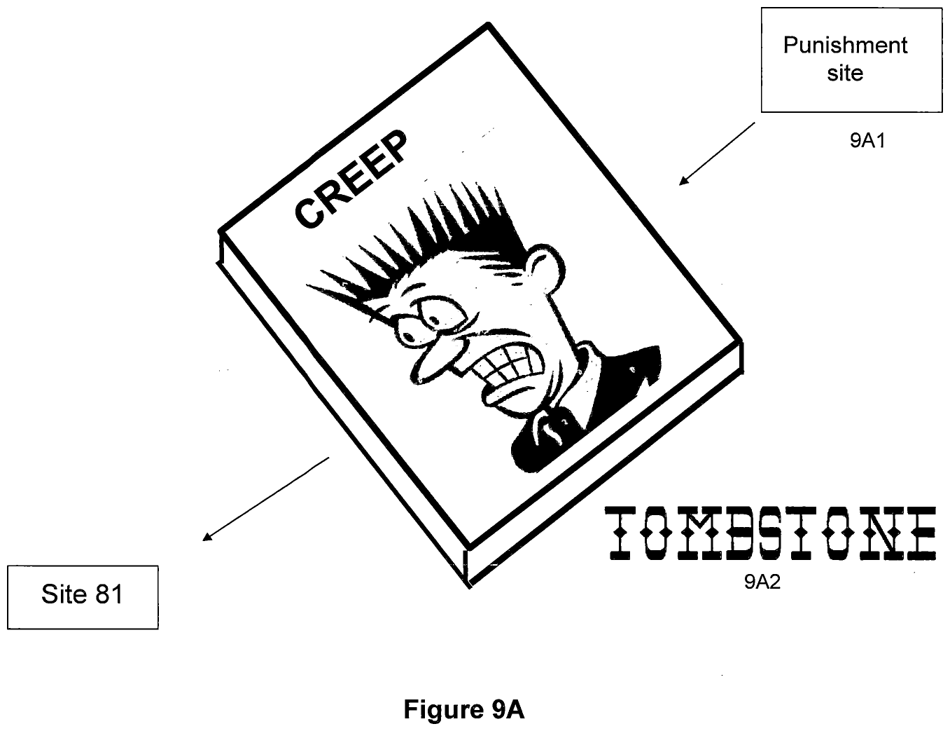

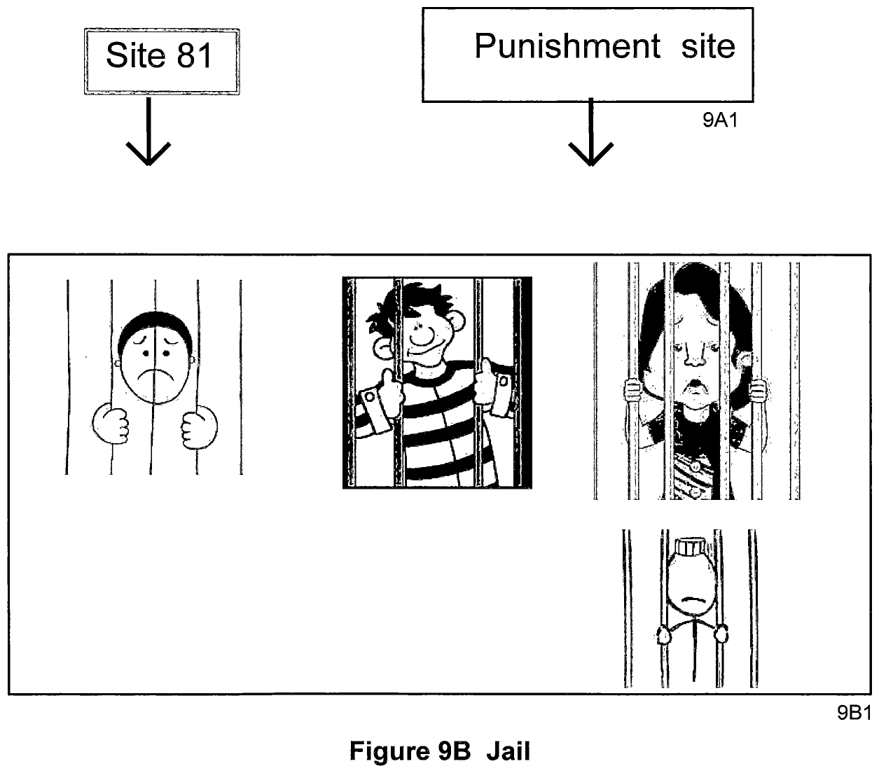

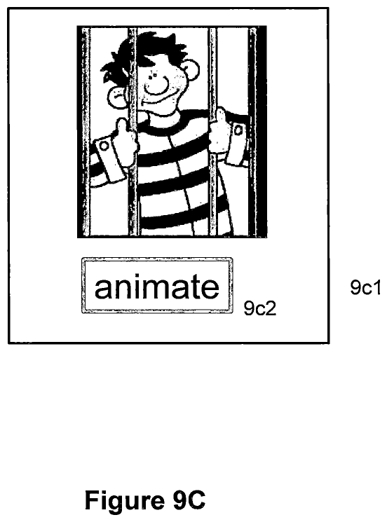

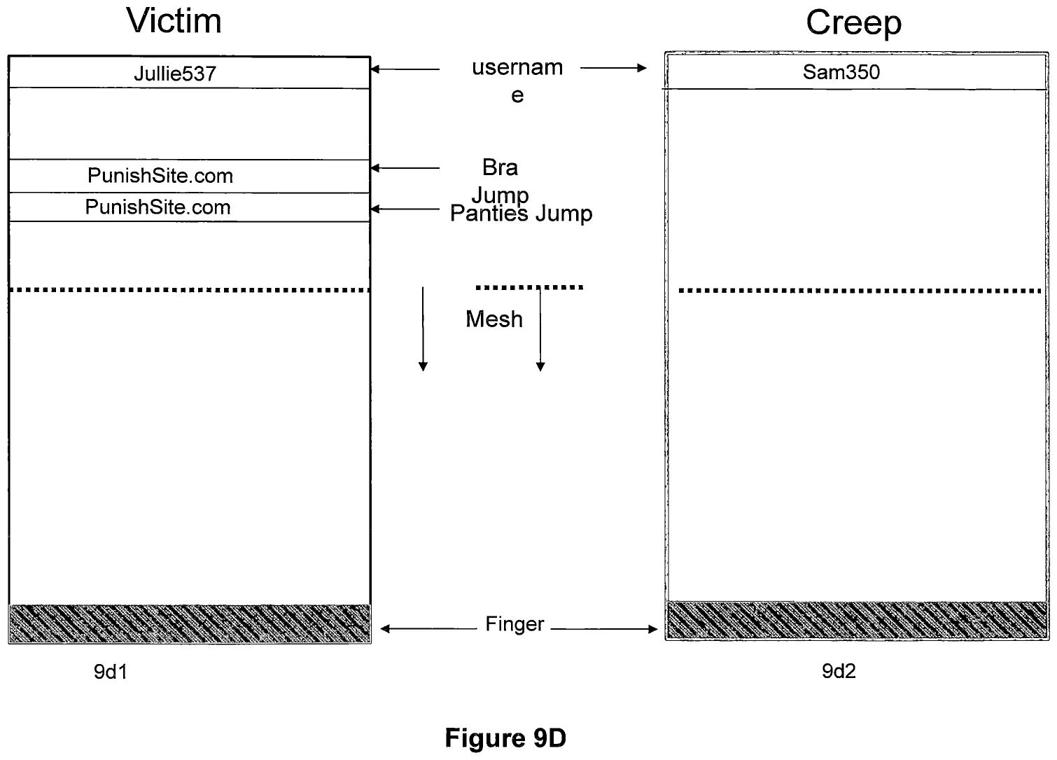

FIG. 9 summarises the above. It shows Creep 83 going to VR site 81. After he gropes another avatar, he is jumped to a punishment site. He tries to jump back to site 81 but is detected and rejected. And FIG. 8 shows site 81 maintaining an avatar blacklist 91, into which a copy of the Creep is put. And this blacklist is uploaded to a global blacklist 92. Which services sundry other VR sites 93

### 5.4] Tombstone—Weaponizing the Jump;

An optional but useful feature is for the punishment site to add a refinement. When the Creep is sent to the site, it subjects him to punishment audio and video. It can take a photo of him as he is subject to this. Any VR site essentially has massive camera ability. We use it here. The punishment site zooms a camera to focus on the Creep. The punishment site makes a slab, which can be (eg) 1 m×1 m. It puts the photo onto the slab, which functions as a “tombstone” slab.

When the Creep was sent to the punishment site from site 81, the punishment site automatically gets the address of site 81. Depending on the functionality of site 81, when it sends the Creep to the punishment site, site 81 might be able to also send the coordinates of the location in site 81 where the victim and Creep were. We assume this is possible. Then, after the punishment site has made a slab with an image of the Creep, the site can send this slab to site 81, near when the Creep was. Thus the slab in site 81 can act as a deterrent to other predators. This also assumes that items that are not avatars can be sent between VR sites, just as avatars can be.

Specifically, this might deter others who formed a posse with the Creep. There have already been cases of groups of predators amassing in early Metaverse sites. Having the predator disappear and then his tombstone appear shortly thereafter, in the previous location of the avatar, is new. The tombstone can be in color, unlike real tombstones. See FIG. 9A. Tombstone 9A2 is made in punishment site 9A1. 9A2 is then sent to site 81.

If site 81 does not have an addressing functionality for locations within it, then the punishment site can send the slab to a default location in site 81. We assume that site 81 has a basic functionality that if it gets several inputs to a same (x,y,z) that site 81 can place the incoming objects (avatars or otherwise) near each other without overlapping. So if several Creeps were sent to the punishment site, and photos of each were sent back as tombstones, the latter can be arrayed as large tiles, near each other, in site 81.

One variant is that instead of a static image on the tombstone, the punishment site can take a short video of the Creep undergoing punishment. This is put onto the tombstone, which then can play it frequently when it is sent to site 81. In the real world, we rarely see videos of the deceased next to a real tombstone.

Whether a video or static image is used on the tombstone, this is a feature of cross-site interaction that is unique to VR/Metaverse, compared to the real world.

FIG. 9A shows the tombstone as laying flat. But it could instead be vertical.

A variant is where the punishment site takes photos or videos and sends these to the original site. The latter can then put these into tombstones in the site. This lets each site use its own creativity to make and embellish the tombstones. The collection of tombstones can act as a deterrent to future predators, and a sign of vigilance, to reassure innocent avatars.

### 5.5] Jail Holding Creeps;

The previous section can be extended. When a Creep Is identified in site 81, then that site and the punishment site each get a copy of the Creep. This is a copy of the polygon map. It may lack the full functionality of the Creep. But it can be used to good deterrent effect. See FIG. 9B. It shows the punishment site 9A1 sending copies of Creeps to Jail 9B2. The copies are exact copies found from the punishment site. Or the copies might be sent directly from the original site 81.

What the Jail gets is not an avatar copy of a Creep but a neutralised map. Unlike an actual avatar, which is still controlled by a human user, the copy has no human user. The copy will likely not move, because of this. Though it might be able to, if the map is sufficiently advanced that it has a basic quasi autonomous movement functionality.

The Jail can put the Creeps behind bars. It might choose to cover the outside surface of some or all Creeps with some type of jail uniform. If a name or nickname of a Creep is known from the original site 81, then the Jail can write this by the Creep's copy.

The Jail might get from site 81 recordings of a Creep's gait and other actions. These actions can include the specific actions done by the Creep where he Infringed on the victim's personal space enough so that he triggered a Jump to the Punishment site. The Jail can articulate the copy of the Creep sufficiently to reproduce its movements up to the moment of infringement.

The Jail might have a search or filtering function available to visitors. They can search by name. By date of jailing. By perhaps a (partial) description (eg “spiky hair”, “black boots”). By race (eg “tiger”, “hyena”, “griffin” “vampire”, “angel”).

The Jail can be visited. Perhaps by humans (using their avatars) who have been accosted or molested by avatars in the past. The humans can try to id their malefactors. Or derive satisfaction by seeing these in jail. This also acts as a deterrent to others.

An avatar run by an innocent person might visit the Jail. She can go to outside a cage holding a specific Creep. There can be a button “animate” outside the cell, that her avatar can press. See FIG. 9C. This button 9c2 will activate the copy of the Creep, showing his actions up to the point when the Creep triggered a Jump to the Punishment site. This lets a new user detect what other users have considered to be bad activity. And the new user can learn and anticipate the Infringing actions of that Creep. So the new user might detect these in perhaps other Creep avatars. Especially if the human who ran that Creep had then made a new Creep, different from the prior Creep. And this human used the new Creep with the same techniques as the previous Creep.

Note that FIG. 9C implies that instead of a human using her avatar to visit the Jail, the human can use a Web browser to visit a website corresponding to the Jail. She can press “animate” in the browser to animate the frozen Creep. This is equivalent to her using her avatar to do it. A third way can be via some type of “app” (possibly a mobile app). But this is likely simply equivalent to the Web browser method.

A variant is where the punishment domain and Jail can be in the same site.

When “animate” is pressed to start up the frozen Creep, in many cases, the starting can be handled by code in the Jail site. A typical Creep avatar can be expected to have animating functionality similar to or the same as most other avatars. The typical avatar is humanoid, with hooks for a human's HUD (or browser) to use to control the limbs. Thus the HUD controls to (eg) move the legs or arms will likely be the same across most avatars.

However, there remains the possibility that a rogue avatar (used by a Creep) may have custom mods deep inside the avatar. In turn, this suggests that animating such an avatar may need detailed analysis of the avatar.

In related ways, the Jail might show recorded video of the Creep interacting with the victim, as another way for a new user to see the Creep's wrong actions.

Another ability of the Jail is to be searchable when a user makes a new avatar. The site in which the user is doing this can compare an image of the new avatar with those in Jail. Two reasons.

One. To warn the user that his avatar choice looks too much like an avatar in Jail. He can be advised to alter his avatar.

Two. The site that has the user's new avatar might increase surveillance of this avatar. And the site, or the Jail site, might warn other sites that this avatar visits.

While the Jail can be populated by submissions from site 81 or a punishment site 9A1, in practise, the punishment site might do most or all of the submissions. There can be several punishment sites in the Internet/Metaverse. And site 81 stands for a generic VR/Metaverse site.

### 5.6] Protecting Kids, Pets;

Suppose a human has avatar kids and pets. For the latter, she might have a dog and cat. The problem is that in her VR site, there is another dog, Grumpy, with a preference for biting kids and pets. She can now make her kids and pets have a clickable Jump each. A Jump is for the entire outer surface of a kid or pet. The Jumps point to a punishment site. The latter might be different than the site for the human-controlled Creep.

Now, the punishment site can depend on how smart Grumpy is. It might be just a simple pseudo-dog; just a simple bot. In this case, the punishment site might just keep it “on ice”. There is little point to doing behavior modification on such a bot. It likely cannot be taught.

### 5.7] Protecting Statues and Museums;

Another case is where there are statues in the VR site. For example, in the real world, the UCLA campus has been mooted as possibly having an VR site. If so, a focal point will be a VR statue of a big bear (the “Bruin’). The problem is that rascals from a nearby campus, USC, are wont to go to the VR UCLA and toss VR paint on the bear.

An answer is for the bear's surface to be a clickable Jump. When the surface is triggered by paint falling on it, the UCLA site can surveil the scene and backtrack the trajectories of the paint, to ascertain from which avatars the paint is coming from. These avatars can be sent to a punishment site.

This use case differs from the previous one, by introducing the presence of the paint trajectory and the backtracking.

Our remarks in this section about statues also pertain to museums in VR. Because VR exhibits cannot be permanently damaged, as in real life, a VR museum has benefits compared to a traditional real world museum. This may be increasingly important. There have been recent cases. Eg. “Climate Activists Throw Mashed Potatoes on Monet Painting”, NY Times 25 Oct. 2022. If climate events become worse, such incidents can in turn be more frequent Leading to museums perhaps being more reluctant to exhibit in real life.

### 5.8] how 2 Avatars Intersect (Touch);

This section gives more details about how to detect when an avatar (eg Creep) touches another avatar. Imagine a woman Julie who buys or makes an avatar. She calls it Julie357. This is the username of the avatar. (An email for Julie could be used instead.) See FIG. 9D. It shows schematics of data structures. Item 9d1 is for Julie. Her username is at the top. Below it, the bra Jump points to punishSite.com. And so does the panties Jump. This is a hypothetical punishment site for other avatars that touch her bra or panties. Below this Is where her Mesh (polygon or triangle) is defined.

For the Creep, see item 9d2. His username is Sam350. His Mesh's area in his data structure Is similar to Julie's. Purely for convenience, for both, we put the values (=coordinates) of their fingers at the bottom in 9d1 and 9d2.

When Creep uses his fingers to touch Julie's avatar, the site finds his fingers' coordinates using 9d2. It looks up his username, Sam350. The site also finds that his fingers touched Julie's avatar's bra. It finds that her username is Julie537, which differs from his. This means he touched her. So the site looks up her Bra Jump value to find where to send him.

But suppose instead, Julie adjusts her avatars bra. Her fingers touch her bra. From 9d1, the site finds that the username corresponding to those fingers is Julie537. But her bra is owned by that username. So the bra Jump is not used.

### 6] Cloud/Mist Link/Jump;

This section describes a new type of link (or jump). Hitherto, there has been the prior art hyperlink, to go from one VR site to another. This is implemented typically as a button on a vertical flat surface, like a wall. We then described in an earlier application, “Metaverse avatar with a clickable link”, how to put the link on an outer surface of an avatar and then have the avatar move.

Now suppose there is a VR room. Inside it an avatar takes out what appears to be an aerosol can. She sprays a mist into part of the room. The mist can stay in the air. It can be immune to gravity. The mist might disperse or not. The mist might have different colours for different parts of it.

The mist can be implemented as droplets. These can be immune to gravity, if a gravity field is used in the room to help orient people and furniture. When motion of a droplet is being found by the VR server, gravity can simply be ignored. We have real world experience with this in the use of a space station and shuttle. However, gravity can be used to model the motion of other items in the room.

The droplets can have a default colour. But for special effects, the colour of a part of the mist can be affected by issues like the type of light source near the mist. Rules can be made for the reflective or refractive colour of a droplet. These can depend on normal physical effects on water droplets. Or they can be new rules that only exist in VR.

When an avatar walks thru the droplets, they might be implemented as small hard balls, that interact with the avatar by bouncing off her.

A hyperlink or jump can be done by an avatar going into the mist. The more droplets she collides with, the greater the chance of a jump. A server keeps a count of how many collisions. If this reaches a chosen number, then a jump happens. Thus we now have a stochastic jump. Unlike the deterministic jumps of earlier.

However, the issue of determinism is somewhat subjective. Suppose the collision limit is 50. The avatar moves and collides with a total of 20, . . . , 39, . . . , 49, 50. Bam! She is sent to a destination site. But it can be argued that when she reached 50, what happened next is deterministic. Instead, the server can implement that when 50 is reached, then a test is done, based on (eg) a probability of 0.75 that the avatar will be sent to a destination site. If not, then the avatar does not go, regardless of how many more droplets she touches.

When the avatar collides with a droplet, there is a choice of possibilities. The droplet can bounce off, so it still persists in the air. Or it can just “evaporate”. The latter is significant Suppose the link in the droplets is to some desirable destination. Then avatars will try to collide with as many droplets as they came. In part to go to that destination. But also to diminish chances of competitors to do likewise.

If an avatar uses the mist to jump, then the remaining droplets could “flash” (=change color or increase brightness) to highlight the jump. This can help other avatars. They can see the flash and be told or reminded about the mist.

A variant is where the droplets dissipate over time. Forcing avatars to be early.

Two competing avatars might spray a room with their mists. One avatar might spray around 1 location, and the other avatar does so at a different location. Or they might spray in the same volume.

### 7] Jump Parameters and Actions;

### 7.1] Burp and Chirp;

When we described a transition from a first VR site to a second VR site, we called it a Jump. This differs from the use of “hyperlink” or “link” in standard Web terminology. We suggested that it is more visceral, more evocative. Especially if the transition involved an avatar. Here we describe some implications. The use of Jump, as an active verb, makes the following more understandable.

In the standard Web, there might be little known to the newly visited website about the user of the browser. But when an avatar is Jumping, the transmitting site knows things about the transmitted avatar. And the receiving site finds out things about the incoming avatar. Suppose the leaving (transmitted) avatar is a “big” avatar, compared to other avatars in the transmitting site. The site could play an audio that somehow tries to convey this to the avatars currently in the transmitting site. The audio might be (eg) a burp, which is mostly low frequency sounds. When the receiving site is getting the avatar, suppose that it too considers the avatar to be “big”. The receiving site might also play a burp. The sounds also alert the avatars already at the transmitting site that such a large avatar is leaving, or has just left.

Likewise, the corresponding sounds played by the receiving site tell the avatars already at that site that a large avatar has just jumped to the site.

Whereas suppose the avatar leaving the first site is considered to be a “small” avatar compared to most avatars who visit the site. Then the first site could emit (eg) a birdsong chirp to tell the avatars currently on the site that a small avatar has left. Similarly, the receiving site could play a chirp to indicate to avatars already there that a small avatar is arriving.

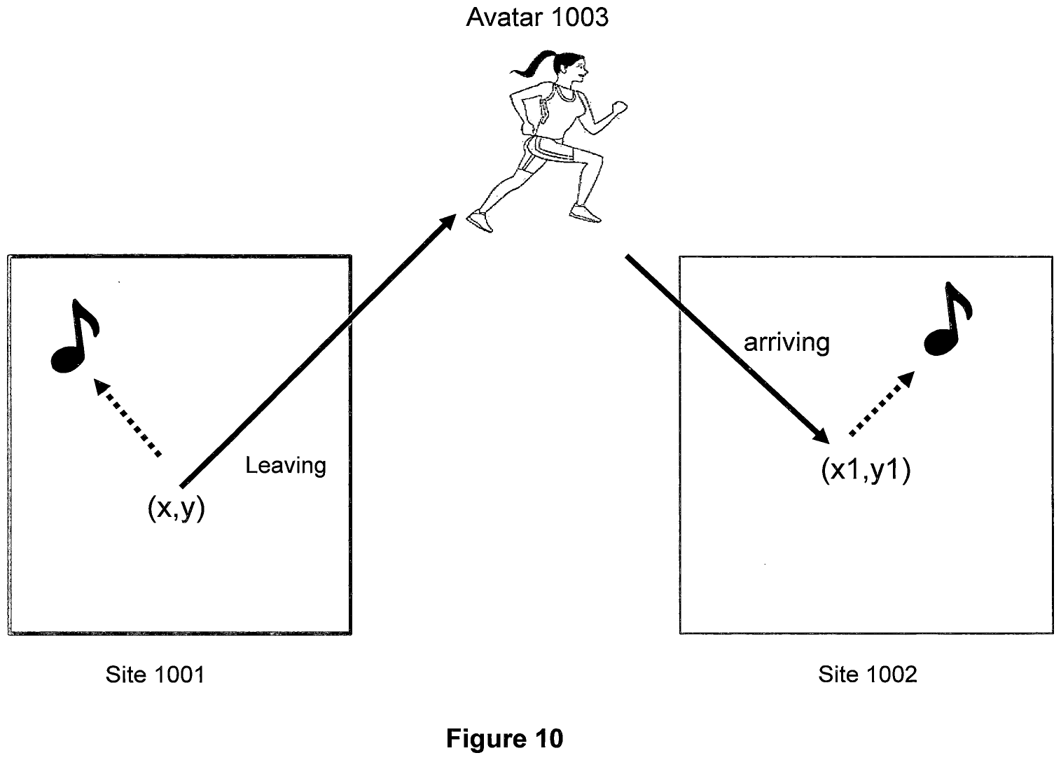

FIG. 10 shows avatar 1003 going from VR site 1001 to VR site 1002. She starts at point (x,y) in site 1001, and ends up at point (x1,y1) in site 1002. When she leaves site 1001, it plays an audio signal to avatars near that location. When she arrives at site 1002, it plays an audio signal to avatars near (x1,y1). While the figure labels the audio as a euphonic sound, by using a musical note at both sites, the audio is not restricted to a “nice” sound.

The sounds emitted could be standardised, to encourage a uniform and consistent GUI. The precise sounds played by both sites might differ from each other. For simplicity here, we assume they are the same across sites, but it is not a necessity.

For gameplay, the above can be useful. Especially in the receiving site. The playing of an audio to alert avatars on a site is similar to how on some laptops, where an application uses the laptop's camera, an LED light then turns on, to remind the user that she is being photographed. Thus one motivation for the audio signals Is etiquette to the avatars (and their users).

When the sounds are played can also be looked at in more detail. One issue is the duration and volume. At site 1001, the leaving audio can start around the time site 1001 gets the click from the avatar owner. The sound can persist for some time after the avatar has transitioned. At site 1002, the arriving audio can start when or just after site 1002 gets a signal that an avatar is coming. The audio can persist for some duration after the avatar has fully arrived in 1002.

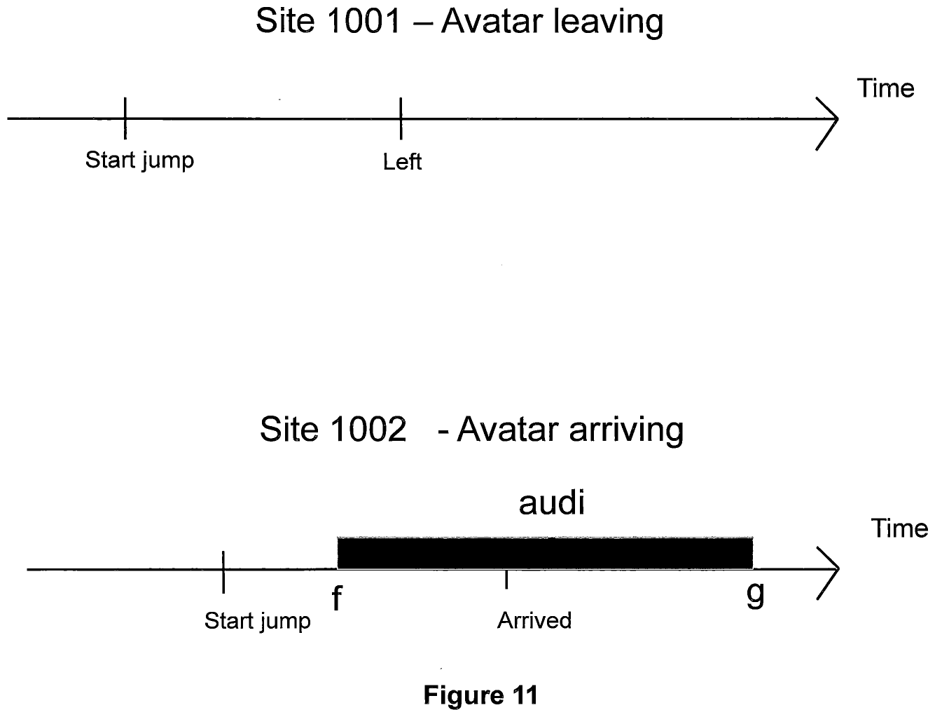

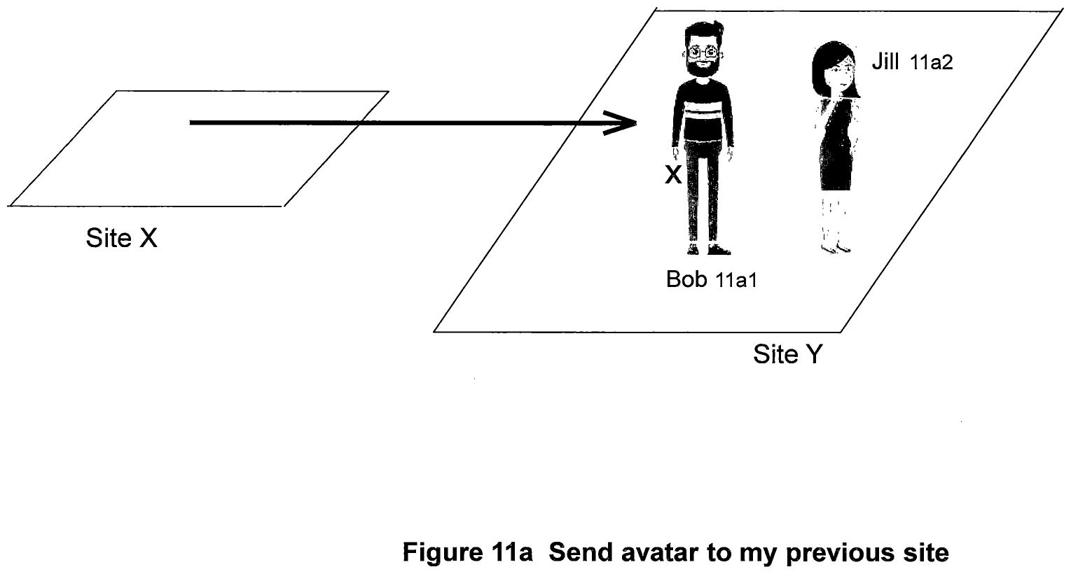

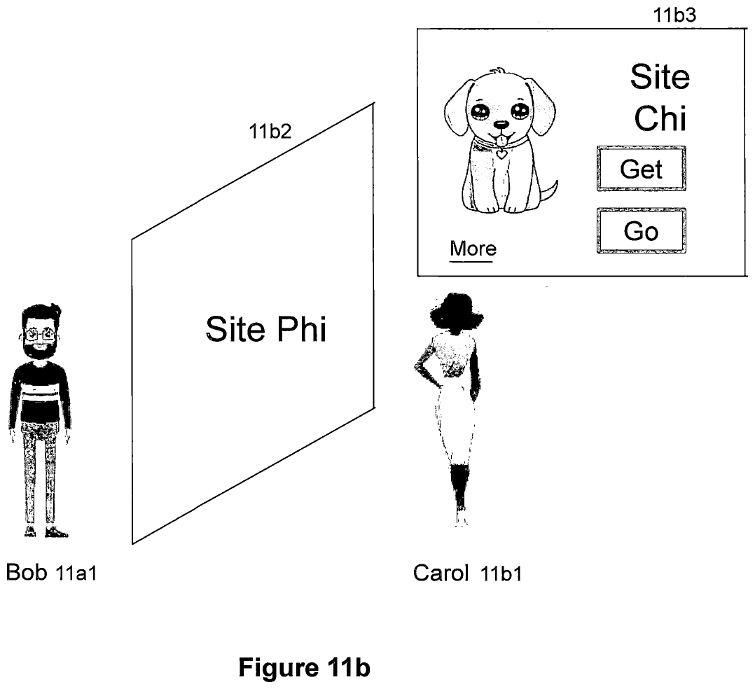

In gameplay, it can be likely more important for other avatars to know when an avatar has arrived, than when it has left. Especially if the avatar is a predator or threat. To this ends, the duration of the arrival signal can be longer than the duration of the leaving signal on the other site. FIG. 11 shows what is essentially a state diagram of the transition. Time flows from left to right. The upper graph shows the transition at site 1001. The ‘start jump’ is when the avatar commences by clicking a link in site 1001. The ‘left’ is when the jump has ended on site 1001.

The lower graph shows ‘start jump’ as the time when site 1002 gets a signal saying “incoming avatar”. The ‘arrived’ mark is when the avatar has been instantiated in site 1002. The filled in rectangle from times f to g is when an audio signal is played in site 1002 to alert other avatars. Site 1002 picks f and g. Notice that the audio continues to play after the avatar has arrived, so g is after ‘arrived’. This is not strictly necessary. Some sites might terminate the audio at time=arrived. For games, site 1002 might charge a larger fee for the longer that g is, because this gives avatars already in the site more time to react to the avatar appearing.

(For simplicity, in FIG. 11 we omit showing the audio at site 1001.)

Note that FIGS. 10 and 11 show how it can be useful to think of the transition between sites as a Jump rather than just a click of a (hyper)link. Jump is more evocative and implies an active motion, whereas link has much less, if any, suggestion of a motion.

Starting from this mindset, FIG. 11 is easier to imagine in the first place.

Another issue is where the audio signal appears in each site. In FIG. 10, we indicated that the signal should come from the location where the avatar left from, or the location where it arrives. Strictly, this is not necessary. The audio can appear across an entire site. But this scales badly into noise if a site has many avatars. It is more germane to avatars that are near the leaving or arrival locations.

Who can hear the audio? Avatars near the place of the leaving or arriving avatar. This might have a fee imposed by the site. The nature of VR means that the fee can be charged. Unlike the real world, the audio does not have to propagate like an actual audio. An avatar who paid to get the signal can hear it in its HUD as a full volume audio. Plus, the audio is or can be undiminished by being partly absorbed by other avatars that are between the sound source and an avatar who hears the sound. In the real world, such persons standing between the sound and a target person can make a significant difference in what the latter hears.

A separate fee can be offered for avatars to get the audio even when they might be too far from the location. Because there is no actual physical audio, this is possible. And the overall condition of the audio not transmitting too far on the site means it is fair to charge avatars outside that artificial audio cutoff range, if they want to be informed of an incoming avatar.

The avatar who pays the fee might specify that it gets an alert audio only for [eg] large avatars or only for small avatars. Suppose there are different “races” of avatars—like vampires and goblins. The avatar might only want to get audio when goblins arrive in the current site, or only when vampires leave the site.

### 7.1.1] Variants;

Look at FIG. 10. The audio emitted by site 1001 is considered to emanate from (x,y), the location of avatar 1003 in the site, when she jumped. But this can be extended so that the audio could emanate from anywhere in the room that avatar 1003 was in, where that room contains (x,y).

This assumes that she was in a room when she jumped. If she is outside, but still in the site, then the audio might be made to come from some volume around (x,y). We deliberately leave this volume unspecified.

Another variant is where the audio is not some type of “music”, but spoken words. These might be (eg) “a big avatar is leaving” or “a big avatar is leaving from this room”. If spoken words are emitted by the site, the words might be recordings made by humans, or TTS (Text To Speech). Given recent improvements in TTS, we consider TTS to be equivalent to human recordings.

If we consider site 1002 that gets the avatar, the audio part of FIG. 11 can be replaced with similar spoken words like “a big avatar is entering this room”.

Another variant is where the site sends text messages to avatars in the vicinity of (x,y) saying (eg) “a small avatar is leaving this room”. We assume that the site is capable of this, and the avatars are capable of receiving such messages. Or perhaps in the room containing (x,y), a written broadcast message can be shown on a “flat screen” (this mimics a real flat screen) that can be seen by avatars in the room. The essential point is that there are several ways that a site can convey to Its avatars that another avatar has left or arrived.

When an avatar is leaving a site and the site then sends out a signal to its users, the signal can include an option. If another avatar picks it, the site sends an image of the leaving avatar.

The preceding variants can be combined in any fashion.

Another variant is where the signals (audio, text, etc) can be sent to an avatar in another VR site, separate from the transmitting and receiving sites. This avatar might want to track or detect changes in one or both of the latter 2 sites. The avatar pays a fee to the transmitting or receiving sites. This lets those sites make some revenue. The signal from a transmitting site can have an option, to let an image of the leaving avatar be shown. Also, when an avatar gets a signal from a receiving site, about an incoming avatar, the signal can have another option. If the avatar picks it, the receiving site will send a picture of the incoming avatar, after it has fully appeared, if possible. Else, if the incoming avatar takes some time to be fully downloaded, the site can have an option for a display of what is currently downloaded.

The latter might be for a game where getting immediate information is more important than waiting for all of it to be known.

### 7.2] Haptic;

The previous section on bump and chirp referred to sounds in the frequency range of roughly 1 kHz to 15 kHz. Haptic effects are also possible. Haptic refers to touch sensitive occurrences. The user might wear gear like special gloves with transducers capable of making haptic feedback. The gloves might give the user an indication of what avatar has disappeared to another site, or appeared on the current site. This can reinforce any feedback given via bump and chirp.

The haptic feedback might only be given when, say, an avatar jumps into the current site that another avatar (with the haptic gloves) is in. This can be a game play effect (or restriction), where it might be more important to know when an avatar arrives near you, than when an avatar leaves your vicinity for another site. The novelty is mainly that the signal conveyed by the gloves is that a nearby avatar has left the site. (Or that an avatar from outside the site has appeared in the room.)

The haptic sensor can be triggered even if (or mostly if) the gloves are not visibly touching a nearby avatar. Thus the Impulses can be seen as “ghostly”. This in itself tells the user that the signal is not about avatars presently on the site.

The haptic glove (or whatever sensor is used for the effect) thus can act as a proximity sensor. Much of current work on haptic gloves has been to simulate touching a nearby object. Here, we suggest its use as a remote sensor. This can be contrasted with its currently mooted uses where the user sees something nearby in his AR/VR vision and then touches it. In our usage, there might be nothing nearby in the user's vision. This can enhance the use of the gloves for our purposes.

Instead of the audio signals made by the site, to indicate to an avatar in the site that another avatar has left or is entering the site, the haptic glove can be used. The site can send a signal to the glove, like a sensation of a touch by another entity, going from left to right along the glove, for example. The wearer of the glove is thus informed that another avatar has left or is leaving the site. While if the site sends a signal to the glove that goes from right to left, this means another avatar is jumping into this site.

Of course, other types of haptic signals can be made. But these examples show how to use the glove. We referred here to one glove. If there are 2 haptic gloves, then more intricate signals can be devised.

The haptic gloves (plural) can be used to give more directional information about an incoming or leaving avatar. The part of the gloves that is closest to the transiting avatar can activate (vibrate in some manner).

### 7.3] Smell;

Suppose a transducer can be used to simulate smells. Currently a Nike™ backed startup RTFKT™ is working on tying customisable digital scents to physical perfumes. We take a different approach here. A VR site can associate a given scent to an avatar with a given property. The latter might be that the avatar is interested in dating. Or the avatar is or will be playing a song. Another avatar could follow the first avatar between sites. Or the first avatar could be advertising a concert happening soon on another site. The first avatar moves thru various sites, emitting a scent trail. Ideally other avatars will follow the scent. And when the first avatar Jumps, so too will others. And they would then follow the scent gradient in the receiving site.

Wouldn't it be easier and simpler for the first avatar to put posters in the sites, telling about the upcoming event? Perhaps. But the use of scents is a different ad channel, that might help break thru a clutter of conventional ads.

A particular smell might be used to deliberately lay a scent trail. A variant is where the scent ends at a Jump point. The point might be implemented as a conventional link put on (eg) a wall. Or as part of the surface of an obliging avatar. The latter might let other avatars following the scent to click the link on itself.

The game can Involve several avatars, each with a different scent. They scatter thru various sites. They are collectively a first group. A second group of avatars tries to sniff out avatars in the first group. There can be other types of clues laid out in various ways on the sites as well. So smell is only 1 way for the second group to track the first group.

### 7.4] Send Avatar to the Previous Site;

See FIG. 11a. It shows avatar Bob 11a1 having Jumped from VR site X to VR site Y. In Y he is near avatar Jill 11a2. When Bob Jumped, into site Y, his right hand now has a link to his previous site X. This Is Indicated by “x” near his right hand. If Jill shakes hands with him, she will Jump to site X.

Depending on site X, the Jump to it may include a location of or near to his location in that site. Thus Jill may be able to Jump to his previous location in site X, or close to it.

Bob might have the feature that when he Jumps to more sites, his right hand's “previous” address will automatically be updated each time. He does not need to do this manually.

Of course, as discussed earlier, his right hand might flash a color to indicated that it is an active Jump. Or, his “previous” field might be updated by a new site whenever he Jumps, but the field need not be automatically active. He might have to do a manual step to activate it.

In passing, the Jump in Bob's hand is in general not for himself but for others he might meet in sites. For him, something like a browser Back button is assumed to exist, so he can trivially go back.

A variant of section 7.4 is where Jill in FIG. 11a came from (eg) site Z. And she has a similar feature in her right hand, that says her “previous” is site Z. Now if Bob and Jill shake hands, they swap their previous sites. He ends up in site Z. She ends up in site X.

As an optimisation, the “previous” variable can be a link in Bob's avatar to his Back variable.

### 7.5] Show the Avatar's Travel History;

This section follows directly from the previous section. Suppose Bob in FIG. 11a had gone to various VR sites, before ending up in site Y. Assume that he has the equivalent of a browser history button, that automatically records his previous sites. But his History we deliberately capitalise to indicate that it is not a trivial recap of a browser history. At many previous VR sites, his avatar automatically recorded images, and maybe even brief video snippets. Then in FIG. 11a, he meets Jill 11a2. He might popup a flat screen that is associated with his History. He scrolls thru it, to show her the sites he was at Imagine that the flat screen appears above or close to his left hand. The screen might also let Jill scroll thru it.

His flat screen can have other features. It might have an interactive talk feature. Jill can talk with another avatar at a given site. This avatar might expound on (eg) why she should visit that site. A motivator is to find new features that can only happen in VR.

One is that in real life, a person can carry a cellphone or tablet. But he cannot easily carry around a PC or (eg) 3 laptops. So he cannot view or show 3 large computer screens. But in VR he can. Bob's flat screen can be (eg) 80 cm diagonal. Immense. This uses the fact that he is in a VR site that can be outdoors. Or if it is indoors, he is in a room that can be conventionally sized, eg 20 m×20 m. Most such rooms can fit very large screens. And when Bob uses his 80 cm screen to show Jill his travels, it can easily have buttons to make a second or a third screen, each of similar or larger size. And these are screens, not tabs in a browser. So all 3 screens can be fully visible at the same time.

FIG. 11b shows Bob with 2 flat screen displays. He is showing Carol 11b1 the flat screen IIb2 for site Phi, and 11b3 for site Chi. Both screens might be showing video from these sites. Site Chi is where Bob visited a VR site for dog lovers. It has a “Go” button. If Carol presses it, she jumps to that location in site Chi that screen 11b3 is currently showing. But if she presses “get”, this will Jump a virtual dog to her current location. Window 11b3 shows a site that Bob visited or is promoting. It shows recorded video or a live feed.

Note that the screens for the sites are different sizes. There is no requirement that they be the same size. Site Phi has no Jump button. Perhaps site Phi is just for avatars near Bob to watch.

Site Chi also has a text “More” that is underlined. The underlining is meant to suggest to the reader that “more” can be clicked to see more details of what is primarily being shown in 11b3. Here, the “more” might either show the extra information in 11b3 or an extra VR window can be opened near 11b3 for that purpose.

The sites can play audio. It is a simple technical trick for (say) stereo sound to come from site Phi. While from site Chi, there might only be mono sound. The reader might well imagine that the sounds from 2 screens could blend into a cacophony heard by Carol. But there can be volume controls present as part of each screen. She can turn up the volume on the screen that interests her.

This overcomes a formidable problem of mobile computers. Most cellphones and laptops cannot easily be shown to 2 or more nearby users. But now Bob can show his travels, or anything else, to an unlimited number of avatars that he finds in site Y.

We can compare the screens in FIG. 11b to a conventional browser history file. The latter is strictly text and shows a list of websites visited by a user. Now in FIG. 11b, the textual listing has been upgraded to a far richer interactive record. And the Figure shows how a screen can act as a portal, to let avatars and bots go in either direction.

### 8] Non VR;

The methods of this application, and the previous Metaverse applications, have all discussed the use within Virtual Reality. But this is not strictly necessary. A non-VR version is possible. Where expensive hardware, like the HUD, is not needed. Instead, a simpler application might be used. Like a web browser-type. Without the VR computations for the user's vision.

Many of the key ideas can still be used. Like a 3d avatar with a clickable link (=Jump). And the Jump can be associated with specific parts of the avatar's surface. And the jump can redirect (=send) the avatar that clicks (=triggers=touches) the Jump to what we termed a punishment domain.

Or a non-VR site can be a multiuser computer application, where the users are stationed at different machines. Which might be PCs, laptops, HUDs. There does not need to be a VR-type effect where light is modelled as tracing “every” possible path from a light source to the eyes of a user.

The non-VR can be combined with the VR. So a first user might have a HUD hardware that lets her see VR generated effects. While a second user might have a web browser that lets him see renditions of graphics that do not use VR. The second user would have a much lesser cost of interacting with various avatars. Though granted, he would not be able to see or do various VR-only effects.

Another case is where Augmented Reality (AR) is used, instead of VR. The attendant hardware might be glasses that show actual scenery thru them, along with an overlay of avatars and related imagery.

In this paper, we use “VR” to also mean “VR/AR”. The latter acronym is cumbersome.

### 9] Eye Protection;

This section should perhaps be part of section 5 on Anti Rape measures. It is separated out because eye protection is not gender specific. However it closely parallels the sexual harassment discussions of that section. A predator (of sexual nature or not) can attack the eyes of another avatar. Unlike real life, this does not physically harm that avatars user. But, just like sexual harassment, it can discombobulate her. It is well known that sexual harassment of an avatar can amount to psychologically stress on the user. Similarly, poking the avatar's eyes can also stress her (the user). This can even be worse than sexual harassment (via groping the breasts or groin), because the avatar's eyes are the users main data input channel. The reader can readily imagine that seeing another avatar poke the readers avatar's eyes will trigger an automic reflex in the reader, just as though the readers eyes had experienced it.

Our answer is, first, to suggest emplacing 2 small safety shields, one on each eye of the avatar. But, just like a big safety shield around the entire (victim) avatar, this is not satisfactory. The predator can walk away after trying to poke her eyes. He can look for other victims.

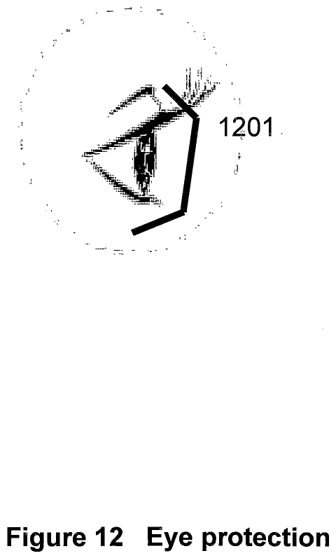

Our second answer is to emplace 2 clickable jumps, one around each eye. Each jump's geometry can be approximately 5 mm (say) away from an eye. The geometry can be done by (eg) copying an approximate outline of the eye, moving it from the face's surface, above and away by that 5 mm. And extending the surface's sides till the sides meet the face's surface. This gives all around protection. FIG. 12 shows a (rough) example. Item 1201 is a profile of such a surface. It is transparent, but is shown as colored in black, merely for illustrative convenience.

The jump can point to the punishment site described earlier in this application and in earlier applications. This is a policy of active deterrence.

10] Jumping from Inside a Crowd;

Bob is an avatar. He is talking to avatar Carol in a crowd of avatars. It is noisy. Anything they say to each other might be eavesdropped by others. Carol has information about other avatars or other VR sites. Based on her conversation with Bob, she can point him to 1 of those sites. She does not want to leave the current site.

Perhaps she only just met him, and she does not want to go with him to another site, where they might be alone. Or perhaps she is duty bound to be in the current room to talk with others.

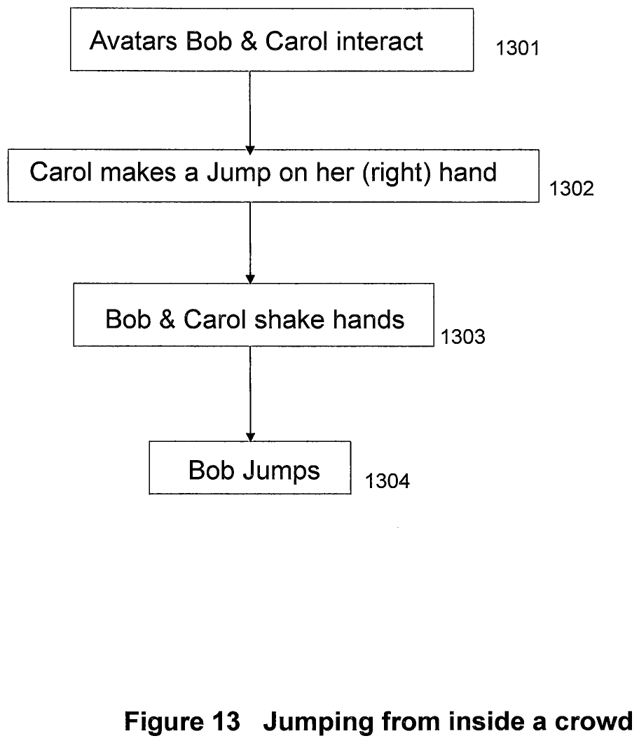

See FIG. 13. Carol does not want to speak out aloud the destination because others can overhear. She also does not want to write it out on a surface, like a piece of VR paper, because others can read it or scan it. Avatars intrinsically have photographic ability.

She does not want to playa “chirp” of the destination address to Bob, because others can hear it and decode it.

If she leans close to Bob and whispers the URL (or uses some other addressing format of the destination), he might only be able to manually transcribe it, which is error prone. Every letter in the address is a source of error. There is a transfer “impedance” between Bob and Carol.

Knowing the destination may be part of her expert knowledge, much like how a salesperson can have a list of clients. Bob will get the address when she somehow tells him, but she does not want others in the room to know. So in FIG. 13, item 1302 is where she makes the Jump destination be for her right hand. In FIG. 9D, item 9D1 is the victim's data fields. Instead of the bra Jump or panties Jump fields, these are replaced by a “generic” destination field. In this, she writes the destination. Here, Carol is not a victim and Bob is not a predator.

Optionally, Carol can have her right hand change color, to indicate to Bob and others nearby that her hand can now trigger a Jump. Perhaps her hand turns red, just as 1 example. Another way is for her hand to flash (eg) red, instead of turning a steady red. This is analogous to how on many personal computers, when a camera facing the user is turned on, and transmits video of the user to other users, that the owner of the PC is warned.

An equivalent way is for her to have the right hand side (or part of it) of her upper clothing (like a blouse) turn red or flash red. Or perhaps she is wearing a bracelet on her right hand. The bracelet can turn red or flash red.

The visual advertising of a Jump being made available is useful to Carol, apart from aiding Bob. It shows to nearby avatars that Carol can send avatars elsewhere. It may prompt others to ask her for more details.

Item 1303 show Bob and Carol shaking hands. This triggers item 1304, where Bob Jumps to the destination. The deliberate use of them shaking hands is to exploit the real world convention of handshakes to facilitate Carol sending Bob elsewhere.

Away of looking at this is to realise that human Carol has data in her biological memory, and also in her various computers, including cellphone, PC, HUD and tablet. And human Carol controls avatar Carol. FIG. 13 is a way for human Carol to transfer some data from human Carol to avatar Carol. And thence to avatar Bob. The simplicity of the steps, especially from Bob's point of view, helps Bob interact with Carol.

In FIG. 13, when Carol makes (picks) a Jump, she is copying the Jump address from her biological memory or computer memory that is outside the VR/Metaverse, to a field in her avatar in the Metaverse. This can be done as a 1 click process, without Carol having to actually type or say the Jump address.

This assumes the address is not already present as a link written on a screen in the VR room. In general, the room has no specific knowledge about the destination used by Carol. That is, there is no connection in terms of who runs the sites, between the site in which Bob and Carol are, and the destination site.

A variant is where Bob and Carol are by themselves, apparently. But there might be bugs in the room, placed by others. The bugs can take any form and can be small.

### 11] Avatar-Avatar Interactions;

A virtual cellphone is irrelevant in VR. When an avatar is walking around, she does not need to be restricted to using a small virtual device in the same way that a human would use a real cellphone. The latter is a compromise that tries to pack as much wireless functionality in as small a volume as possible. But in a virtual space, the avatar does not need to do this. Essentially, the avatar absorbs a real cellphone into itself.

But when 2 avatars are near each other and interacting, often this means information is passing between them. Perhaps one way, perhaps bi-directional. Each avatar is its own area of memory in the site server, and these are walled off from each other. If we regard the problem as being the interaction between avatars (ie pseudo human constructs in a virtual space), rather than interactions between memory areas in a computer, then we can do the former as visual metaphors to get understanding. The site server can, in general, analyze any avatar's memory being held in the site memory. This can be considered a “God's eye” view. Thus the site can know when a first avatar touches a second avatar. More specifically, the site knows if the first avatar has touched a “forbidden” area of the second avatar. This is how the site can then know that it needs to send (=transport) the first avatar to the destination indicated by a Jump (=hyperlink) that points to the destination.

Note that the walled areas of memory are in the memory of the site server. The latter can and does inspect and alter these areas, as part of its normal duties. So, for example, suppose 2 avatars jointly get assets from a third avatar. (See section [11.1].) This interaction is mediated by the site server. It makes a new area of memory where it stashes the acquired assets. Then over some time interval (like 5 minutes, 30 minutes), that is realistic for the humans who own those avatars, the humans can decide how to allocate the assets between their avatars.

See FIG. 11a. Avatar Bob Jumps from site X to site Y, where he meets avatar Jill. She wants to go to the site X that he came from. He makes his right hand be the launch pad for a Jump to site X. He shakes hands with her. This triggers Jill to Jump to site X.

Site X is the most recent in Bob's History. Suppose instead Jill wants to go to the site Bob was at, before he Jumped to X. Bob can bring up his History in various screens and Jill can pick. But there is a shortcut.

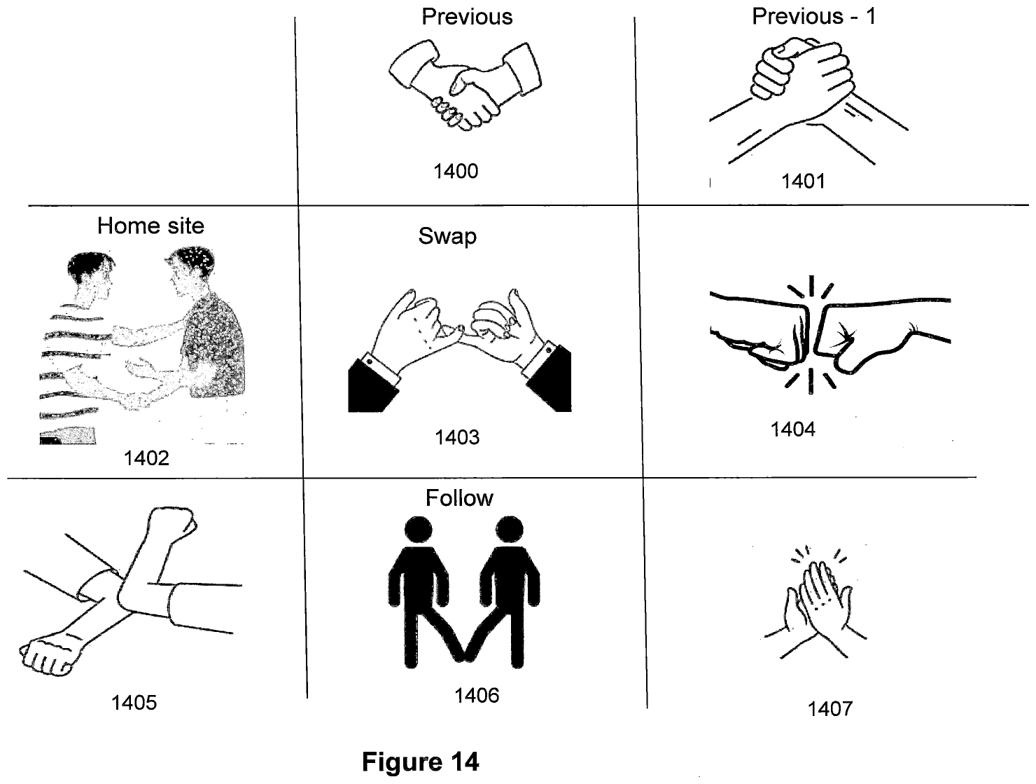

FIG. 14 shows item 1401. Where if Jill and Bob interact this way, Jill is saying she wants to Jump to Bob's previous-1 site. Bob then can encode this Jump into his right hand and they clasp hands as shown. Bob sensitises his right hand so that when Jill shakes it this can initiate a sending of her to that destination. Bob also has to detect that his right shoulder is touched by Jill. More strictly, she has to touch it with her left hand, as shown. These 2 touchings of Bob then trigger the Jumping of Jill to Bob's previous-1 destination.

Item 1402 is where “Jill” wants to Jump to Bob's home site (if he has one). Jill is represented by the male figure on the left. When she puts her left hand on Bob's right shoulder, it has this meaning.

Item 1403 is where Jill and Bob each goes to the other's immediate previous site. They swap their previous locations.

Items 1404, 1405, 1406 are other possibilities. Note that Item 1405 shows elbow bumps with both avatars using right elbows. The use of left elbows is possible and can point to another Jump. Likewise i406 represents 4 types of foot bumps. Right foot bumping right root, left foot bumping left foot, right foot bumping left foot. Left foot bumping right foot. Item 1404 represents left fist bumping right fist, left fist bumping left fist, right fist bumping left fist, right fist bumping right fist.

Item 1407 shows what is known in real life as a “high 5” between 2 people.

The items all have in common that there is at least 1 touching intersection between the 2 avatars. This is desirable for a Jump to happen.

When a Jump causes Jill to go to a location defined by Bob, the Jump can, by default, try to send her to Bob's particular location in that destination site. But this might not be possible. Eg if that location is currently occupied by another avatar. If so, then the destination site might try to place Jill by various criteria:

[1] Put Jill as close to the desired location as possible.

[2] Put Jill at a default location that many avatars go to when they first arrive at the site.

[3] Put Jill at a location near as many avatars currently in the site as possible. This assumes, perhaps rightly, that Jill, like many others, wants to be near avatars.

[4] If Jill had previously visited the destination, and the destination still has a record of her most recent location, then try to put Jill there, if it is not already occupied by a current avatar. Or, if so, as close to her previous location as possible.

There are many other touching configurations possible other than what is shown in FIG. 14.

Note that item 1402 is where Jill shakes hands with Bob and her left hand touches his right shoulder. Bob has to change his avatar so that it can detect that his right hand touches Jill's right hand, and that the right shoulder side of his shirt is sensitised to be touched, and it is then touched by Jill. Or perhaps that his right shoulder is touched by Jill, if he is shirtless. For other cases where Jill touches Bob with 2 parts of her body, similar alterations have to be made to the 2 avatar interaction.

For item 1405, it is just 1 part of each avatar that touches. Here, Bob has to activate his avatar so that its right elbow (or the part of his shirt covering his right elbow) can be touched. Jill has to change her avatar so that touching can only be done by her right elbow or by the part of her shirt covering her right elbow.

A user with an avatar does not have to remember all these meanings. Instead she can, via her HUD or other device or browser, pick a given interaction from (eg) a menu presented to her. A given choice is then auto-implemented by her avatar, using its limbs and body, and any necessary choice of Jump that she has to make is done. The latter is likely to happen prior to the moving of her avatar limbs. Thus Jill delegates her avatar's body motions to her avatar's “mind”.

When 2 avatars interact in the ways shown above, the end result does not have to be any Jump. It can be entirely non-Jump. See item 1406. For example, it might be that once this 2 person interaction is done, then Jill walks away from Bob. He follows her at (eg) around 10 meters behind her. He can stop this and so something else. But this default following lets the human Bob to do something else (eg visit the toilet, get a coffee) while his avatar is on autopilot. This is still an avatar-avatar interaction, even though no Jump is involved.

### 11.1] Taxonomy;

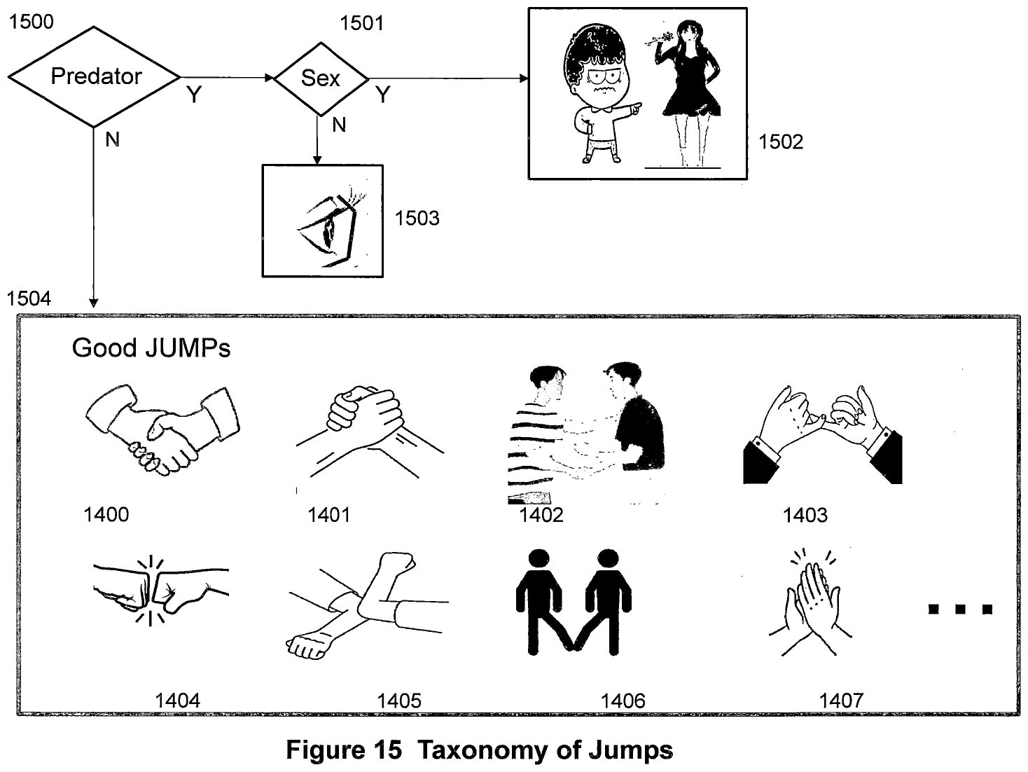

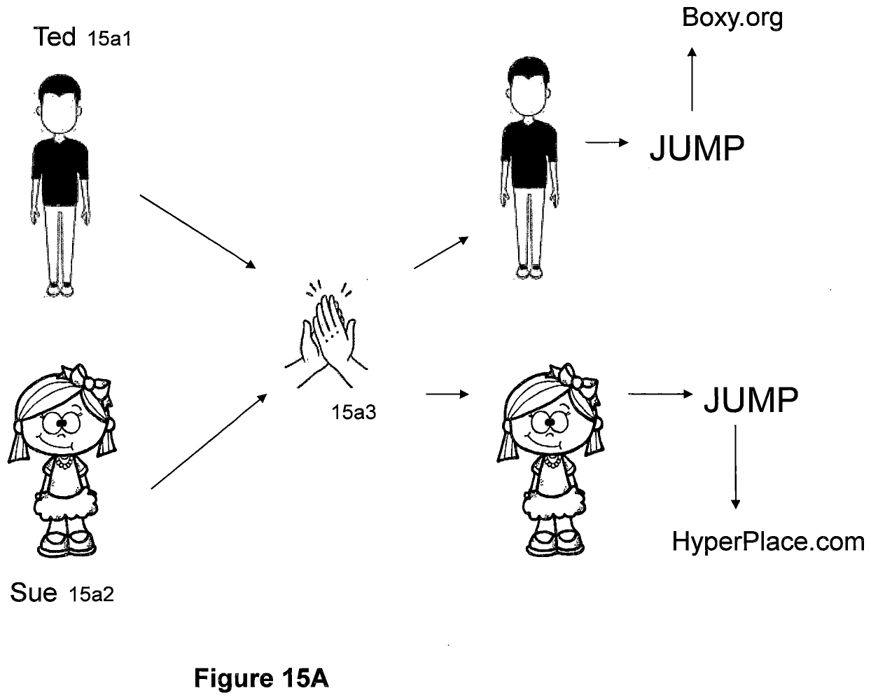

FIG. 15 shows the taxonomy of avatar-avatar interactions that (mostly) involve Jumps. Start at the top left. Item 1500 asks “are we dealing with a predator?”. If yes, go to item 1501, which asks “is it a sexual predator?”. If yes, then the avatars being defended make links in item 1502 from their underwear to punishment sites. If no, then we are dealing with a predator that might do eye jabs at our avatar. So in item 1503, it makes eye protection and links these to a punishment site. I

In terms of non-sexual assaults in the Metaverse, if there is another type of such an assault, then the chart of FIG. 15 can be modded to put this new assault next to the eye poke of item 1503. Likewise, for a new type of sexual assault, then this can be added next to item 1502. There is enough structure in the figure to cater to the adding of new types.

Now go back to item 1500. If there is no predator, then we have benign avatar-avatar Interactions. These are cooperative. Item 1504 groups these as Good Jumps. Items in this box are taken from FIG. 14. We represent the interactions by their human-human equivalents. We suggest that this is the most meaningful way. Associated with each avatar-avatar “manual” interaction is coding, for 1 or both avatars, in order to implement the interaction. The 3 dots in the lower right of 1504 means there are more Jumps. The Jumps explicitly shown in 1504 are what we might consider to be (or will be) the most common. Because of Covid, the fist bump and elbow bumps are likely to be already well known to many readers. The foot bump less so.

The mapping from a given 2 avatar interaction in item 1504 to the corresponding Jump is here left unspecified. One case is where, say, the most common 4 interactions have well defined Jumps. While remaining interactions might have different underlying Jumps. The most common 4 can have the Jumps defined in many or all avatars by default. While the others can depend on different groups of users. A first group has a specific definition of 1 or more of the foot bumps. (There are 4 possible foot bumps.) A second group can have a different set of Jumps for those foot bumps. The first group might be Russian. The second group might be Indian. Groups could be defined by nationality or language, for example.

When a specific item in FIG. 15 has several subvariants, these might be depicted in a way similar to what the periodic table does. For example, the foot bump variants that derive from item 1406 can be shown as a horizontal set of variants, akin to how the Lanthanides are depicted as rows in the periodic table.

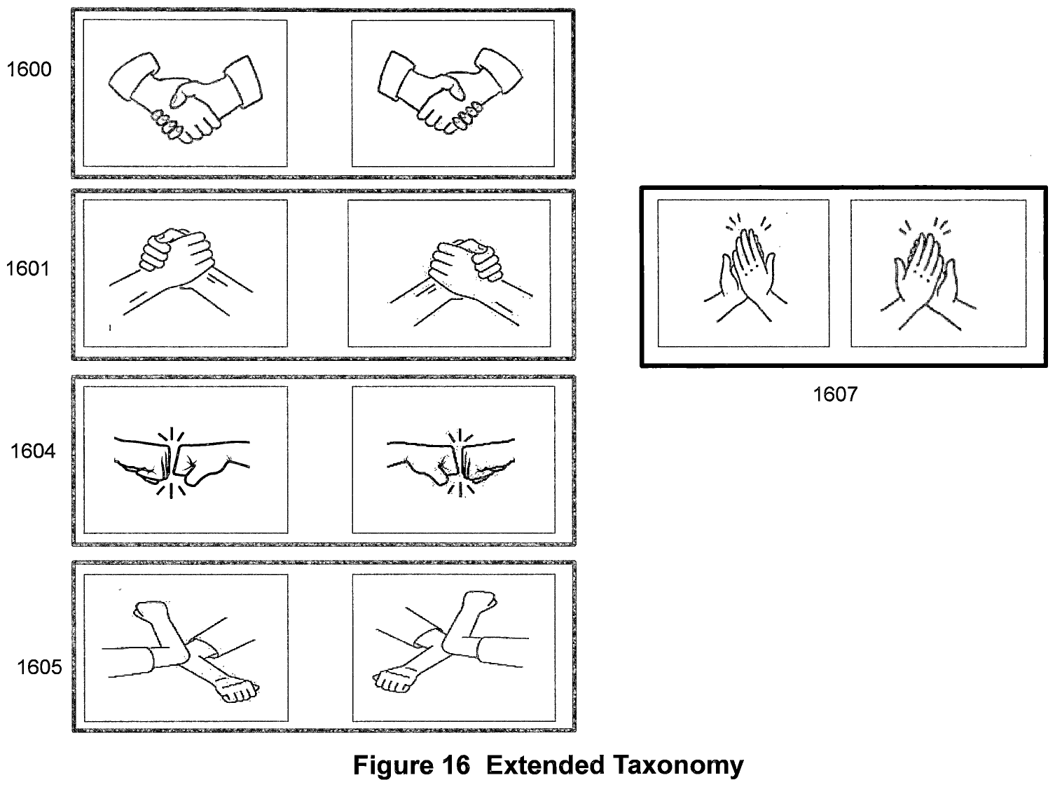

FIG. 16 extends FIG. 15. It expands 4 of the items in FIG. 15 into items 1600, 1601, 1604, 1605. These 4 groupings follow the original items 1400, 1401, 1404, 1405. Each of the 4 items in FIG. 16 is then expanded into 2 mirror cases. Each of the latter then can be expanded into and represents an actual Jump.

See FIG. 15a. In a site 15a0, it shows avatars Ted 15.1 and Sue 15a2. Ted started off in a site HyperPlace.com, while Sue started off in Boxy.org. Both went to various other sites and ended up at site 15a0. They interact and demonstrate this to any other avatars nearby by doing the high 5 15a3. This triggers Ted JUMPing to Boxy.org, while Sue JUMPs to HyperPlace.com. Here the meaning of the high 5 is that it sends each avatar to the originating site of the other avatar.

There can be a difference between Jumps used against predators and the good Jumps of item 1504. Against predators, as soon as if the predator touches the victim's underwear, he is Jumped to a punishment site. As quickly as possible, he should be separated from the (intended) victim. But for (eg) a handshake interaction, the Jump might wait until the handshake is completed, and then wait 1 second or so before implementing the Jump. There is no or little sense of transgression against either avatar. And waiting a few seconds for the interaction to complete also lets this conform to real world social customs. This duration of wait can be a function of how much the avatars have interacted with each other. Either in the current site, or across different sites over some period of time. A longer wait might be associated with avatars with a long history of interactions or, conversely, with a short history. Here, a reasoning might be that this gives the avatars with a long history more time to exchange goodbyes.

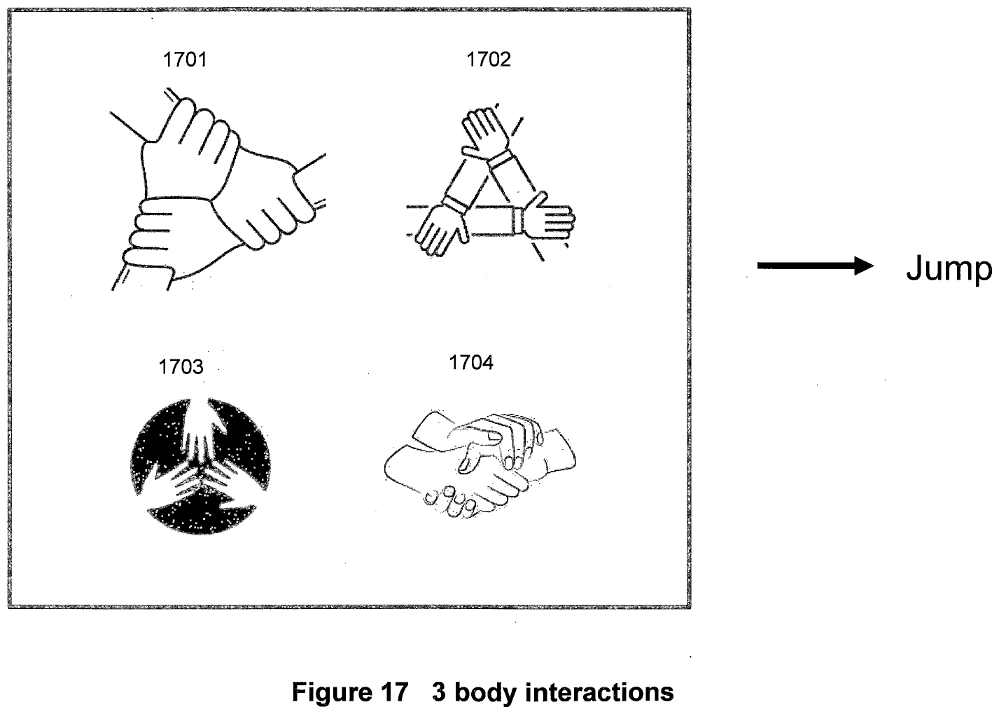

FIG. 17 also extends FIG. 15. It shows some 3 body interactions, where for “body” we specialise to “hand”. These interactions are for (presumed) benign interactions between 3 avatars. Item 1073 can be imagined where the fingertips touch. FIG. 17 is not complete. Other 3 hand configurations can be imagined. Also, just like FIG. 16 described how an item in FIG. 15 could be expanded into variants that are mirror-image-like, so too FIG. 17 can be expanded into variants.

Each 3 hand interaction can be associated with a Jump. This can mean all 3 avatars Jump to the same destination. Or perhaps 2 avatars Jump to a destination furnished from the third avatar. The destination might be one that the third avatar has come from, either just before it jumped to the current site, or from an earlier action. Or the destination is a site that hired the third avatar to publicise it.

Another result can be where the 3 avatars touch, and this initiates an interaction not visible to other avatars or users. And where some data is passed between the 3. The common touching of hands might trigger that non-visible (to other avatars) interaction. Or the non-visible interaction might have already occurred and the 3 avatar interaction designates its successful completion.

A non-Jump might be where 2 avatars follow the third avatar as it moves thru the site that all are currently in. A different non-Jump can be where the 3 avatars redistribute some virtual assets between them. A different non-Jump can be where the 3 humans who control the 3 avatars, swap ownership or control of the avatars between themselves. Such swapping might be permanent or for some duration, after which ownership of the avatars reverts to the original owners.

Yet another non-Jump can be where an avatar distributes some or all of its assets to the other 2. Because these are virtual, there is no physical transfer. Instead the receiving avatars jointly hold the received assets. Later, they divvy up those assets between them. The first avatar has moved on, after the 3 avatars touched hands. The virtuality of the received assets means there can be a software “bag” that holds the received assets. This bag is controlled by the site server. The duration of time between the receiving of the assets and the divvying gives time for the human owners to decide on who owns which assets. Here, the first avatar might get a set of assets from the other 2. This set would have been agreed upon by the 2 avatars, prior to meeting the first avatar. They would see the list of preferred assets and then offer some of their own.

For the special case of gaming, the first avatar might offer some assets that are ammo, arrows, weapons. And the other 2 avatars might offer food and potions of healing. Each side tries to offer assets that they do not critically need, while getting (hopeful) assets that they do critically need.

The cataloging of Jumps helps emphasise that interactions between 2 or more avatars are a core attribute of the Metaverse/VR/AR or general computer applications with avatars. It walks away from what appears to be a current feature of the Metaverse—the building and populating of elaborate artificial structures, like buildings and flight simulators. This Is important, but equivalent to writing a long document in a Markup Language. This was pioneered for a mass audience by Apple with the Macintosh in 1984-9. But it was superseded by the rise of hypertext in 1989.

The taxonomy can cause the Metaverse to focus on avatar-avatar interactions.

We claim:

1: A system of a first avatar starting jumping from a first Virtual Reality (VR) site to a second VR site;
the second VR site receiving a signal indicating that the first avatar wants to arrive;
the second VR site receiving data about the first avatar;
the data including a polygon mesh describing the first avatar;
the second VR site broadcasting a first audio in the second VR site, signifying an arrival of the first avatar;
the first audio playing around a location of arrival of the first avatar;
the first audio playing for a first duration before the arrival of the first avatar;
the first audio playing for a second duration after the arrival of the first avatar.

2: The system of claim 1, where:
the first VR site broadcasts a second audio signifying a departure of the first avatar;
the second audio playing around a point of departure of the first avatar;
the second audio playing for a third duration before the departure of the first avatar;
the second audio playing for a fourth duration after the departure of the first avatar.

3: The system of claim 1, where:
the first audio signifies an estimate of a size of the first avatar.

4: The system of claim 2, where:
the second audio signifies an estimate of a size of the first avatar.

5: The system of claim 1, where
the second duration is longer than the first duration.

6: The system of claim 1, where a second avatar, in the second VR site, pays a fee to the second VR site;
the second VR site sends a signal to the second avatar when the first avatar jumps to the second VR site;
the signal can be any combination of [a] audio, [b] text, [c] graphics, [d] haptic, [e] smell.

7: The system of claim 6, where the audio can be any combination of [a] sounds vocalized by a human, [b] sounds generated by a computer.

8: The system of claim 6, where the signal can be shown or broadcast from a VR surface inside the second VR site.

9: The system of claim 1, where a third avatar is in a third VR site;
the third avatar pays a fee to the second VR site;
the second VR site sends a signal to the third avatar when the first avatar jumps to the second VR site;
the signal being one of [a] indicating an arrival of the first avatar in the second VR site, [b] indicating a departure of the first avatar from the first VR site.

10: A system of anti-harassment, using a first VR site, a second VR punishment site, a first avatar and a second avatar;
the first VR site containing the first avatar and the second avatar (“Predator”);
the first avatar and the Predator being in proximity;
the first avatar having transparent covers over each eye;
each cover having a clickable link (“Jump”) pointing to a second VR site;
the Predator poking the first avatar in an eye of the first avatar;
the poking triggering a Jump of the Predator to the second VR site;
the first VR site storing a copy of the Predator;
the second VR site playing audio and video to the Predator;
the audio and video being a punishment experience.

11: The system of claim 10, where a return of the Predator to the first VR site is hampered by:
the first VR site black adding a network address of the punishment site to a blacklist;
the first VR site receiving an incoming request from an avatar at the punishment site;
the first VR site finding a network address of the avatar;
the first VR site finding the network address in the blacklist;
the first VR site rejecting the incoming request.

12: The system of claim 10, where a return of the Predator to the first VR site is hampered by:
the first VR site getting a partial copy of an avatar from a different address;
the first VR site comparing the partial copy to the copy of the Predator held by the first VR site;
the first VR site finding a match between the partial copy and the copy of the Predator;
the first VR site rejecting the copy of the Predator from the different address.

13: A system of a VR site hosting a model avatar and an audience of other avatars;
the model providing the site with polygon meshes of her nude, and of her underwear and clothes;
the model parading fully clothed in front of the audience;
a first avatar in the audience watching the model;
the first avatar seeing a list of the clothing of the model, and a fee next to each clothing item;
the first avatar paying a first fee to the site;
the first fee corresponding to a first clothing item.
the first avatar seeing the model not wearing the first clothing item;
a second avatar not paying the first fee;
the second avatar seeing the model wearing the first clothing item.

14: The system of claim 13, where:
different avatars see the model in different stages of undress.

15: The system of claim 13, where:
a second avatar in the audience sends the model virtual clothing, accessories and jewelry to wear, and a suggested payment;
the model getting the payment;
the model wearing the items from the second avatar.

16: The system of claim 15, where:
only the second avatar can see the model wearing the items offered by the second avatar.

17: The system of claim 16, where:
the second avatar and other avatars in the audience, can see the model wear the items the second avatar offered.

18: The system of claim 13, where the model wears a veil over her face;
a third avatar in the audience pays an unveiling fee to the model;
the third avatar sees the model, without the veil;
other members of the audience see the model, wearing the veil.

19: The system of claim 13, where different audience members offer different clothing, hats, jewelry for the model;
where each audience member sees, concurrently, the model wearing his choices of clothing for her.

20: The system of claim 13, where different audience members choose what tattoos the model wears on her visible surface;
each audience member sees, concurrently, the model wearing his choices of tattoos for her.
